(19) United States
(12) Patent Application Publication
(10) Pub. No.: US 2007/0225102 A1
(43) Pub. Date: Sep. 27, 2007

(54) Hydraulic pressure control apparatus of automatac transmission

(75) Inventor: Kiyoharu Takagi, Okazaki-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/723,105

(22) Filed: Mar. 16, 2007

(30) Foreign Application Priority Data
Mar. 23, 2006 (JP) 2006-080562

(51) Int. Cl. F16H 31/00

(52) U.S. Cl. 475/123; 475/128

(57) ABSTRACT

A hydraulic pressure control apparatus for an automatic transmission having plural engaging elements (a first engaging element and a second engaging element) includes plural control valves (a first control valve and a second control valve) controlling each engaging element by supplying controlled hydraulic pressure as output pressure, plural shift valves for switching an oil passage for the line pressure, a fail valve closing an input port and a fail output port thereof while the output pressure is supplied from the second control valve; wherein, once the line pressure is supplied to the control valve through a supply port and a drain port thereof, it outputs the line pressure from as output pressure, and once the line pressure is supplied to the fail valve through the input port and a release port thereof, it outputs the line pressure as output pressure.

### CROSS REFERENCE TO RELATED APPLICATIONS

This application is based on and claims priority under 35 U.S.C. § 119 to Japanese Patent Application 2006-080562 filed on Mar. 23, 2006, the entire content of which is incorporated herein by reference.

### FIELD OF THE INVENTION

The present invention relates to a hydraulic pressure control apparatus for an automatic transmission for simultaneously controlling engaging elements to be in an engaged state or in a disengaged state by means of, for example, a solenoid valve operated by hydraulic pressure from a hydraulic pressure source, and specifically, a failsafe and traveling performance can be improved by such hydraulic pressure control apparatus.

### BACKGROUND

A known hydraulic pressure control apparatus for an automatic transmission employs a so called clutch-to-clutch control system by which each engaging element is simultaneously controlled to be in an engaged state or in a disengaged state, by means of a solenoid valve directly operated by hydraulic pressure from the hydraulic pressure source, in order to provide a smooth and high level response shift feeling.

Such hydraulic pressure control apparatus for the automatic transmission includes plural control valves, plural shift valves and an electronic control unit. Each control valve controls hydraulic pressure from a hydraulic pump depending on an amount of electric power supplied to the linear solenoid valve so as to generate controlled hydraulic pressure, and the control valve outputs such controlled hydraulic pressure.

Each shift valve switches an oil passage for hydraulic pressure depending on an energized/de-energized state of an on/off solenoid valve in order to select an appropriate frictional engagement element to which the controlled hydraulic pressure is introduced from the control valve.

The electronic control unit controls electric power supplied to the linear solenoid valve and the on/off solenoid valve. In this configuration, the plural frictional engagement elements are operated to be in an engaged state/disengaged, and depending on a combination of the engaged element and the disengaged element, an appropriate shift stage is selected (JP2001-280468A, JP2005-163916A).

According to the hydraulic pressure control apparatus disclosed in JP2001-280468A, in order to reduced the number of the linear solenoid valves, the shift valve and the on/off solenoid valve are used instead of the linear solenoid valve for supplying line pressure to the engaging element. Further, the linear solenoid valves are selectively used to obtain each shifting pattern, and although it has a limit, in order to deal with a skip shifting, an interlock is avoided by use of the fail valves (120, 130 and 140 in FIG. 3 disclosed in JP2005-163916A), at any case except a third shift stage fixed mode of a shifting pattern 3 (a S1 is energized, a S2 is energized, and a S3 is de-energized).

According to the hydraulic pressure control apparatus disclosed in JP2005-163916A, the shifting pattern is categorized into a shifting transitional state and a steady traveling state, and in the shifting transitional state, failsafe valves are not operated in order to improve control response ability (43, 44 and 45 in FIG. 4 disclosed in JP2005-163916A), and in a fixed mode of the steady traveling state, the failsafe valves (43, 44 and 45 in FIG. 4 disclosed in JP2005-163916A) are operated by means of switching ON-OFF solenoid valve (36, 37 and 38 in FIG. 4 disclosed in JP2005-163916A) in order to sustain the fixed mode.

When the clutch-to-clutch control is executed by means of the solenoid valve, while a reactive element (an engaging element unchanged its state, and a reactive force is applied thereto) has been sustained upon the shifting operation, an time adjustment is made so that an assigned torque for the disengaged element (an engaging element changed from the engaged state to the disengaged state upon the shifting operation) and an assigned torque for the engaged element (an engaging element changed from the disengaged state to the engaged state upon the shifting operation) are controlled so as to be appropriately overlapped each other, and in order to switch from the disengaged element to the engaged element smoothly, a solenoid valve needs to be provided on each the reactive element, the engaging element and the disengaged element (line pressure may be supplied to the reactive element). In this configuration, if the solenoid valves fail to operate properly while it is energized, an interlock may happen. In order to avoid this situation, the fail valve close the connection between the solenoid valve and the engaging element, or the fail valve stops supplying hydraulic pressure.

On the other hand, in order to avoid a decline of control performance, as disclosed in JP2005-163916A, the shifting patterns are set by means of the ON-OFF solenoid valve and the shift valve in order to categorized the shifting pattern into the shifting mode and the fixed mode.

Further, according to the hydraulic pressure control apparatus disclosed in JP2001-280468A, because the shifting pattern is the shifting mode at any case except the third shift stage fixed mode of the shifting pattern 3 (the first on/off solenoid valve S1 is energized, the second on/off solenoid valve S2 is energized, and the third on/off solenoid valve S3 is de-energized), an interlock can be avoided by means of the fail valve, and when the fail valve fails to operate properly, the interlock is avoided in fixed mode.

However, in JP2001-280468A, when a spool of the fail valve (120 in FIG. 3) becomes stuck while electric power is supplied thereto, in the shifting pattern 1 (the first on/off solenoid valve S1 is energized, the second on/off solenoid valve S2 is de-energized, and the third on/off solenoid valve S3 is de-energized) only the first friction clutch C1 is in an engaged state so as to establish a neutral N (C1) (a first shift stage if first shift stage OWC is provided). In the shifting pattern 2 (the first on/off solenoid valve S1 is energized, the second on/off solenoid valve S2 is de-energized, and the third on/off solenoid valve S3 is energized) and the shifting pattern 3 (the first on/off solenoid valve S1 is energized, the second on/off solenoid valve S2 is energized, and the third on/off solenoid valve S3 is energized), only the first friction clutch C1 is in an engaged state so as to establish a neutral N (C1) (a first shift stage if first shift stage OWC is provided). The shifting pattern 4 (the first on/off solenoid valve S1 is energized, the second on/off solenoid valve S2 is energized, and the third on/off solenoid valve S3 is de-energized) of a fixed pattern is similar to the above mentioned situation. In the shifting pattern 5 (the first on/off solenoid valve S1 is de-energized, the second on/off solenoid valve S2 is energized, and the third on/off solenoid valve S3 is de-energized) and the shifting pattern 6 (the first on/off solenoid valve S1 is de-energized, the second on/off solenoid valve S2 is energized, and the third on/off solenoid valve S3 is energized), only the second friction clutch C2 is in an engaged state so as to establish the neutral N (C2). In the shifting pattern 7 (the first on/off solenoid valve S1 is de-energized, the second on/off solenoid valve S2 is de-energized, and the third on/off solenoid valve S3 is energized), when the linear solenoid valve (80) outputs pressure B1 (hydraulic pressure supplied to the first friction brake), a sixth shift stage can be established, and when the linear solenoid valve (80) does not output the pressure B1, the neutral N (C2) can be established. On the other hand, when the spool becomes stuck while electric power is not supplied thereto, an interlock may occur at any case except the shifting pattern 4 (the first on/off solenoid valve S1 is energized, the second on/off solenoid valve S2 is energized, and the third on/off solenoid valve S3 is de-energized) of the fixed pattern, as a result, the failsafe and the traveling performance may be degraded.

According to the hydraulic pressure control apparatus disclosed in JP2005-163916A (FIG. 5), in the shifting mode (shifting transitional state: the SLC1 is in a “∘” state, and the SLC2 is in a “∘” state), the failsafe valve is not operated, however, there is other three patterns of an avoiding mode: the SLC1 is in a “x” state, and the second control valve unit SL2 is in the “x” state (a first shift stage, a fourth shift stage, a fifth shift stage, and a sixth shift stage); the SLC1 is in the “x” state, and the SLC2 is in the “∘” state (a second shift stage, an eighth shift stage); and the SLC1 is in the “∘” state, and the SLC2 is in the “x” state (the third shift stage and a seventh shift stage). In this configuration, when the spool of the fail save valve becomes stuck while electric power is supplied thereto, the shift stage is degraded, and when the spool of the fail save valve becomes stuck while electric power is not supplied thereto, an interlock may occur. Even if the fixed shift is employed, the fail save and the traveling performance may be degraded in the same manner as that in the apparatus disclosed in JP2001-280468A.

A need thus exist to provide a hydraulic pressure control apparatus by which a failsafe and traveling performance can be improved.

### SUMMARY OF THE INVENTION

According to an aspect of the present invention, a hydraulic pressure control apparatus for an automatic transmission having plural engaging elements for switching a shift stage by means of a combination of supplying hydraulic pressure to at least one of the plural engaging elements and draining hydraulic pressure from the other of the plural engaging elements includes plural control valves each having a supply port, a control output port and a drain port for controlling each engaging element to be in an engaged state or in a disengaged state by supplying controlled hydraulic pressure as output pressure, the controlled hydraulic pressure being generated by controlling line pressure supplied to the supply port of the each control valve on the basis an amount of electric power supplied thereto, the plural engaging elements including a first engaging element and a second engaging element, the plural control valves including a first control valve and a second control valve, the first control valve corresponding to the first engaging element, and the second control valve corresponding to the second engaging element, plural shift valves for switching an oil passage for the line pressure supplied from a hydraulic pressure source to the supply port or the drain port of the each control valve, the second control valve supplying controlled hydraulic pressure to the second engaging element which is interlocking with the first engaging element when each of the first engaging element and the second engaging element is simultaneously in an engaged state; a fail valve provided at one of: an oil passage provided between the first control valve and the first engaging element, or an oil passage provided between the hydraulic pressure source and the first control valve, having an input port, a fail output port and a release port; and the fail valve closing the input port and the fail output port thereof while the output pressure is supplied from the second control valve corresponding to the second engaging element; wherein, once the line pressure is supplied to the control valve through the supply port and the drain port thereof, the control valve, whose drain port is connected to the hydraulic pressure source or a exhaust circuit, outputs the line pressure from the control output port as output pressure, and once the line pressure is supplied to the fail valve through the input port and the release port thereof, the fail valve, whose release port is connected to the hydraulic pressure source or the exhaust circuit, outputs the line pressure from the fail output port as output pressure.

### BRIEF DESCRIPTION OF THE DRAWINGS

The foregoing and additional features and characteristics of the present invention will become more apparent from the following detailed description considered with reference to the accompanying drawings, wherein:

FIG. 1 illustrates a schematic view indicating an entire configuration of a hydraulic pressure control apparatus for an automatic transmission related to the first embodiment of the present invention;

FIG. 2 illustrates a skeleton diagram of the automatic transmission of the hydraulic pressure control apparatus for the automatic transmission related to the first embodiment of the present invention;

FIG. 3 illustrates a table indicating relations between: a first friction clutch C1, engagements/disengagements of a second friction clutch C2 and a third clutch friction clutch C3, an the first friction brake and a second friction brake B2; and corresponding shift stages of the automatic transmission;

FIG. 4 illustrates a partial hydraulic pressure circuit schematically indicating a configuration of a hydraulic pressure control unit of the hydraulic pressure control apparatus for the automatic transmission related to the first embodiment of the present invention;

FIG. 5 illustrates a table indicating a relation between each shifting pattern and each driving range, which is set according to the controlling state of the hydraulic pressure control unit of the hydraulic pressure control apparatus for the automatic transmission related to the first embodiment of the present invention;

FIG. 6 illustrates a partial hydraulic pressure circuit diagram indicating an operation in a 1-2 shifting mode of the hydraulic pressure control apparatus for the automatic transmission related to the first embodiment of the present invention;

FIG. 7 illustrates a partial hydraulic pressure circuit diagram indicating an operation in a 2-6 shifting mode of the hydraulic pressure control apparatus for the automatic transmission related to the first embodiment of the present invention;

FIG. 8 illustrates a partial hydraulic pressure circuit diagram indicating an operation in a first shift stage fixed mode of the hydraulic pressure control apparatus for the automatic transmission related to the first embodiment of the present invention;

FIG. 9 illustrates a partial hydraulic pressure circuit diagram indicating an operation in a second shift stage fixed mode of the hydraulic pressure control apparatus for the automatic transmission related to the first embodiment of the present invention;

FIG. 10 illustrates a partial hydraulic pressure circuit diagram indicating an operation in a third shift stage fixed mode of the hydraulic pressure control apparatus for the automatic transmission related to the first embodiment of the present invention;

FIG. 11 illustrates a partial hydraulic pressure circuit diagram indicating an operation in a fourth shift stage fixed mode of the hydraulic pressure control apparatus for the automatic transmission related to the first embodiment of the present invention;

FIG. 12 illustrates a partial hydraulic pressure circuit diagram indicating an operation in a fifth shift stage fixed mode of the hydraulic pressure control apparatus for the automatic transmission related to the first embodiment of the present invention;

FIG. 13 illustrates a partial hydraulic pressure circuit diagram indicating an operation in a sixth shift stage fixed mode of the hydraulic pressure control apparatus for the automatic transmission related to the first embodiment of the present invention;

FIG. 14 illustrates a schematic partial hydraulic pressure circuit diagram indicating a configuration of the hydraulic pressure control unit of the hydraulic pressure control apparatus for the automatic transmission related to an example 1;

FIG. 15 illustrates a table indicating a relation between each driving range and each shifting pattern set according to the controlling state of the hydraulic pressure control unit of the hydraulic pressure control apparatus for the automatic transmission related to the example 1;

FIG. 16 illustrates a schematic partial hydraulic pressure circuit diagram indicating a configuration of the hydraulic pressure control unit of the hydraulic pressure control apparatus for the automatic transmission related to an example 2; and

FIG. 17 illustrates a table indicating a relation between each driving range and each shifting pattern set according to the controlling state of the hydraulic pressure control unit of the hydraulic pressure control apparatus for the automatic transmission related to the example 2.

### DETAILED DESCRIPTION

### First Embodiment

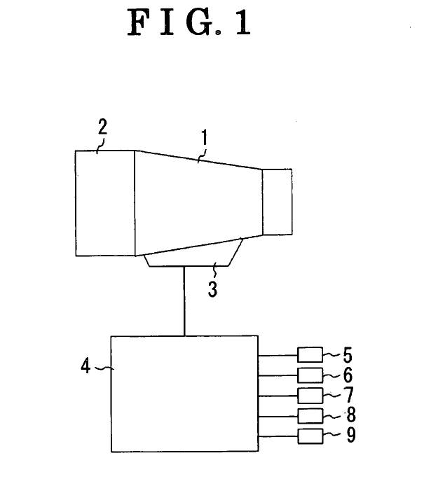

A first embodiment of the present invention will be explained in accordance with the attached drawings. FIG. 1 illustrates a schematic view indicating an entire configuration of a hydraulic pressure control apparatus for an automatic transmission related to the first embodiment of the first invention. The hydraulic pressure control apparatus for the automatic transmission includes an automatic transmission 1, a hydraulic pressure control unit 3 and an electronic control unit 4. Specifically, the automatic transmission 1 is connected to an output shaft (not shown) of an engine, the hydraulic pressure control unit 3 controls a hydraulic pressure supplied to hydraulic pressure-driven type engaging elements (not shown), which is provided within the automatic transmission. The electronic control unit 4 controls an operation of solenoids (not shown) provided within the hydraulic pressure control unit 3.

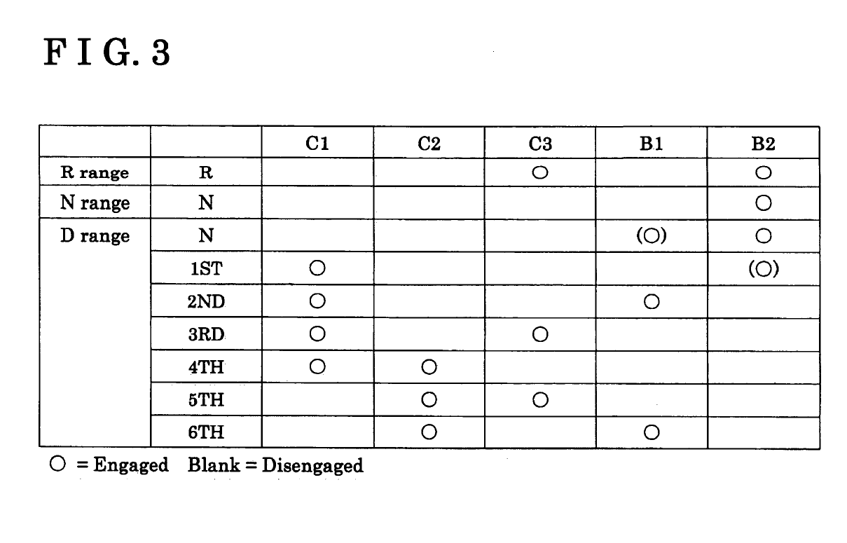

The electronic control unit 4, having a microcomputer, is connected to each of an engine speed sensor (Ne sensor) 5, an input shaft speed sensor (Nt sensor) 6, an output shaft speed sensor (No sensor) 7, a throttle position sensor (θ sensor) 8 and a position sensor 9. Each sensor works as follows. The engine speed sensor (Ne sensor) 5 detects a rotation speed Ne of the output shaft of the engine 2, the input shaft speed sensor (Nt sensor) 6 detects a rotation speed Nt of an input shaft 11 of the automatic transmission 1, the output shaft speed sensor (No sensor) 7 detects a rotation speed (corresponding to a speed of a vehicle) of an output shaft 12 of the automatic transmission 1, the throttle position sensor (θ sensor) 8 detects a throttle position (opening) (corresponding to an engine load) θ of the engine 2, and the position sensor 9 detects an position (driving range) of a selector lever operated by a driver of the vehicle. Each sensor outputs detection signal, and on the basis of each detection signal, the electronic control unit 4 controls electric power supplied to a first control valve unit SL1, a second control valve unit SL2, a third control valve unit SL3, a fourth control valve unit SL4, a first on/off solenoid valves S1, a second on/off solenoid valves S2 and a third on/off solenoid valves S3 in order to achieve a required shift stage (see FIG. 3).

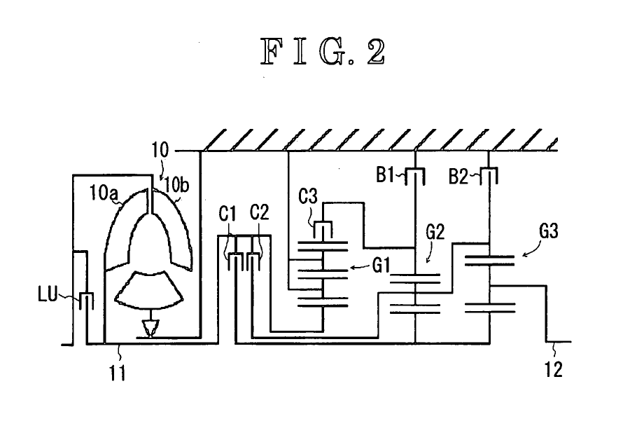

FIG. 2 illustrates a skeleton diagram indicating the automatic transmission of the hydraulic pressure control apparatus related to the first embodiment of the present invention. The automatic transmission (identified by a numeral 1 in FIG. 1) includes a torque converter 10, an input shaft 11, an output shaft 12, a first double-pinion planetary gear train G1, a second single-pinion planetary gear train G2 and a third single-pinion planetary gear train G3.

Specifically, the torque converter 10 is connected to the output shaft of the engine (identified by a numeral 2 in FIG. 1). The torque converter 10 has a pump impeller 10b at an input side, a turbine runner 10a at an output side and a lock-up clutch LU. In this configuration, in a case where a rotation difference between the pump impeller 10b and the turbine runner 10a is relatively small, the lock-up clutch LU directly connects the pump impeller 10b to the turbine runner 10a in order to transmit rotations so that a transmission loss of rotation caused by a fluid loss can be reduced.

More specifically, the input shaft 11 functions as an output shaft of the torque converter 10. The output shaft 12 is connected to an axle of the vehicle via a differential gear (not shown). The first double-pinion planetary gear train G1, the second single-pinion planetary gear train G2 and the third single-pinion planetary gear train G3 are connected to the input shaft 11.

The automatic transmission 1 includes plural (six) frictional engagement elements such as a first friction clutch C1, a second friction clutch C2, a third friction clutch C3, a first friction brake B1, a second friction brake B2 and a lock-up clutch LU. At the automatic transmission 1, by means of the hydraulic pressure control unit (identified by a numeral 3 in FIG. 1) and the electronic control unit (identified by a numeral 4 in FIG. 1), the first friction clutch C1, the second friction clutch C2, the third friction clutch C3, the first friction brake B1 and the second friction brakes B2 are selectively operated so as to be in an engaged state or a disengaged state, and an required shift stage and a shifting pattern can be selected by means of pattern combinations of the frictional engagement elements.

The lock-up clutch LU is controlled by the hydraulic pressure control unit (identified by a numeral 3 in FIG. 1) and the electronic control unit (identified by a numeral 4 in FIG. 1) so as to be in an engaged state in a case where the driving range is selected within ahead stages, and a rotation difference between the pump impeller 10b and the turbine runner 10a is relatively small. At the third single-pinion planetary gear train G3, a one-way clutch OWC may be provided so as to be parallel to the second friction brake B2. Each of the first friction clutch C1, the second friction clutch C2, the third friction clutch C3, the first friction brake B1, the second friction brake B2 and the lock-up clutch LU is controlled to be in an engaging state when a high hydraulic pressure is supplied thereto by means of the hydraulic pressure control unit 3, and controlled to be in a disengaged state when a low hydraulic pressure is supplied thereto by means of the hydraulic pressure control unit 3. The second friction brake B2 may be divided into tow brakes B2S and B2L.

FIG. 3 illustrates a table indicating an engaging state and a disengaging state of the first friction clutch C1, the second friction clutch C2, the third friction clutch C3, the first friction brake B1 and the second friction brake B2 at each shift stage. In this embodiment, the automatic transmission can achieve six shift stages of forward movement and one shift stage of rear movement, specifically the automatic transmission can achieve: an under drive including a reverse, a neutral, a first gear stage, second gear stage, third gear stage, fourth gear stage; and an over drive including a fifth gear stage and a sixth gear stage.

More specifically, while each of the third friction clutch C3 and the second friction brake B2 is in an engaged state, and the others are not in a engaged state (in a disengaged state); the output shaft (identified by the numeral 12 in FIG. 2) is rotated in an opposite direction of the rotation of the input shaft (identified by the numeral 11 in FIG. 2) so that the vehicle moves in a reverse direction. The neutral can be achieved when the second friction brake B2 is in an engaged state. The first gear stage can be achieved when each of the first friction clutch C1 and the second friction brake B2 is in an engaged state, and the others are in a disengaged state. The second gear stage is achieved when each of the first friction clutch C1 and the first friction brake B1 is in an engaged state, and the others are in a disengaged state. The third gear stage can be achieved when each of the first friction clutch C1 and the third friction clutch C3 is in an engaged state, and the other is in a disengaged state. The fourth gear stage can be achieved when each of the first friction clutch C1 and the second friction clutch C2 is in an engaged state, and the others are in a disengaged state. The fifth gear stage can be achieved when the second friction clutch C2 and the third friction clutch C3 are in an engaged state, and the others are in a disengaged state. The sixth gear stage can be achieved when each of the second friction clutch C2 and the first friction brake B1 is in an engaged state, and the others are in a disengaged state. The table in FIG. 3 also indicates driving ranges such as R range (reverse range), N range (neutral range) and D range (drive range), which are selected by the driver operating the operation lever (not shown), and the abovementioned shift stages (R, N, 1-6) are categorized in each range.

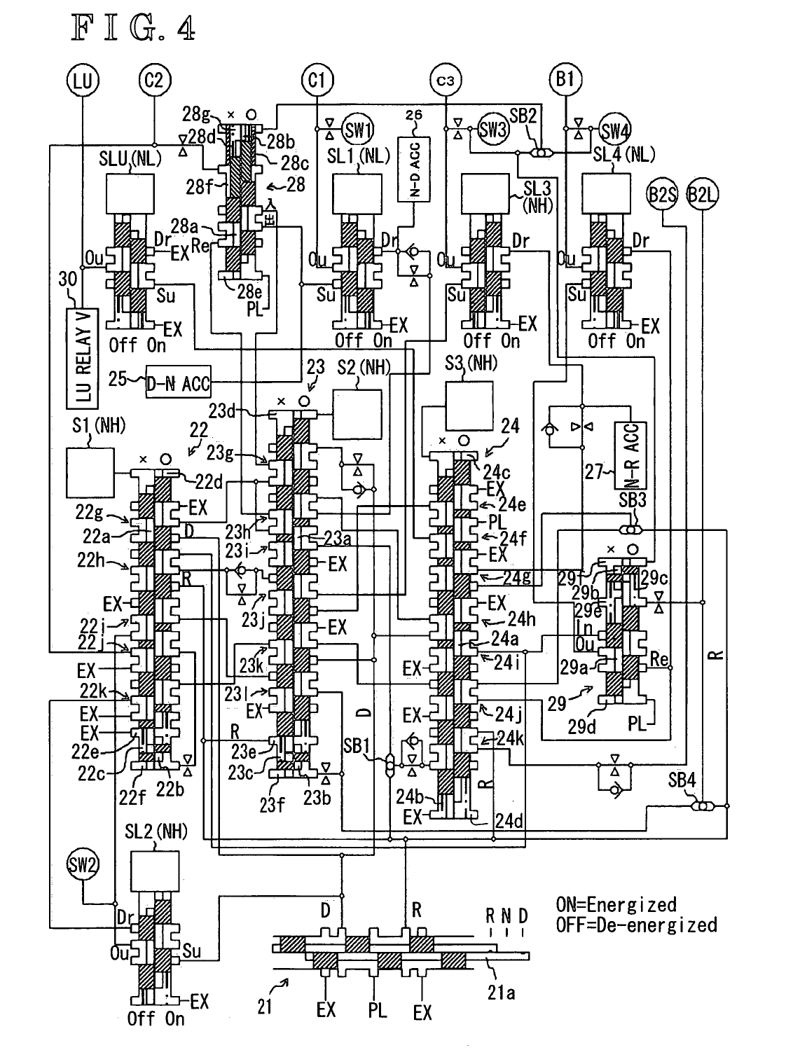

A configuration and a controlling manner of the hydraulic pressure control unit of the hydraulic pressure control apparatus for the automatic transmission related to the first embodiment of the present invention will be explained in accordance with the attached drawings. FIG. 4 illustrates a partial hydraulic pressure circuit diagram schematically indicating the configuration of the hydraulic pressure control unit of the hydraulic pressure control apparatus for the automatic transmission related to the first embodiment of the present invention.

The hydraulic pressure control unit 3 includes a first control valve unit SL1 (e.g., serving as a control valve unit), a second control valve unit SL2 (e.g., serving as a control valve unit), a third control valve unit SL3 (e.g., serving as a control valve unit), a fourth control valve unit SL4 (e.g., serving as a control valve unit), a LU control valve unit SLU (e.g., serving as a control valve unit), a manual valve 21, a first shift valve 22, a second shift valve 23, a third shift valve 24, a first on/off solenoid valve S1, a second on/off solenoid valve S2, a third on/off solenoid valve S3, a D-N accumulator 25, a N-D accumulator 26, a N-R accumulator 27, a first fail valve 28, a second fail valve 29, a first hydraulic switch SW1, a second hydraulic switch SW2, a third hydraulic switch SW3, a fourth hydraulic switch SW4, a LU relay valve 30 and a first shuttle valve SB1, a second shuttle valve SB2, a third shuttle valve SB3 and a fourth shuttle valve SB4.

The first control valve unit SL1 is a control valve unit for controlling the first friction clutch C1 and is composed of an integrated combination of the linear solenoid valve and the spool valve. The first control valve unit SL1 may include the linear solenoid valve and the spool valve separately. The first control valve unit SL1 introduces output pressure (pressure D) from the first fail valve 28 through the supply port Su thereof. At this point, on the basis of the output pressure (pressure D) of the first fail valve 28 introduced to the first control valve unit SL1 depending on an the amount of the electric power thereof, the first control valve unit SL1 generates controlled hydraulic pressure, and such controlled hydraulic pressure is outputted from an output port Ou (e.g., serving as a control output port) thereof. When the output pressure (pressure D) of the first fail valve 28 is introduced through the supply port Su of the first control valve unit SL1, at the same time, output pressure (pressure D) of the second switching circuit 23h of the second shift valve 23 is introduced through the drain port Dr of the first control valve unit SL1, the first control valve unit SL1 outputs pressure D not depending on whether the first control valve unit SL1 is energized or de-energized. Output pressure (pressure SL1) of the first control valve unit SL1 is supplied to the first friction clutch C1 and the first hydraulic switch SW1. The first control valve unit SL1 employs a normal low type (NL) configuration, in which the pressure SL1 is not outputted in a de-energized state, and the pressure SL1, which is increased as an electric current is increased, is outputted in an energized state. Further, in the de-energized state, the output port Ou of the first control valve unit SL1 is connected to the drain port Dr of the first control valve unit SL1.

The second control valve unit SL2 is a control valve unit for controlling the second friction clutch C2 and the second friction brake B2L and is composed of an integrated combination of the linear solenoid valve and the spool valve.

The second control valve unit SL2 may include the linear solenoid valve and the spool valve separately. The second control valve unit SL2 introduces output pressure (pressure D) from the pressure D port of the manual valve 21 through the supply port Su thereof. At this point, on the basis of the output pressure (pressure D) from the pressure D port of the manual valve 21 introduced to the second control valve unit SL2 depending on an the amount of the electric power thereof, the second control valve unit SL2 generates controlled hydraulic pressure, and the controlled hydraulic pressure is outputted from the output port Ou. When the output pressure (pressure D) from the pressure D port of the manual valve 21 is introduced through the supply port Su of the second control valve unit SL2, at the same time, output pressure (pressure D) of the fifth switching circuit 22k of the first shift valve 22 is introduced through the drain port Dr of the second control valve unit SL2, the second control valve unit SL2 outputs pressure D not depending on whether the second control valve unit SL2 is energized or de-energized. The output pressure (pressure SL2) of the second control valve unit SL2 is supplied to the second hydraulic switch SW2, and the pressure SL2 is supplied to the second friction clutch C2 through the fourth switching circuit 22j of the first shift valve 22 being in a “∘” state. The pressure SL2 is also supplied to the second friction brake B2L via a third switching circuit 22i of the first shift valve 22 being in a “x” state, a sixth switching circuit 231 of the second shift valve 23 being in a “∘” state and a fourth shuttle valve SB4. The second control valve unit SL2 employs a normal high type (NH) configuration in which maximum pressure SL2 is outputted in a de-energized state, and SL2 pressure, which is decreased as the electric current increases, is outputted in the energized state. The output port Ou of the second control valve unit SL2 is connected to the supply port Su of the second control valve unit SL 2 in the de-energized state.

The third control valve unit SL3 is a control valve unit for controlling the third friction clutch C3 and is composed of an integrated combination of a linear solenoid valve and a spool valve. The third control valve unit SL3 may includes the linear solenoid valve and the spool valve separately. The third control valve unit SL3 introduces output pressure (pressure PL or pressure R) of the fourth switching circuit 23j of the second shift valve 23 through the supply port Su. At this point, on the basis of the output pressure (pressure PL or pressure R) from the fourth switching circuit 23j of the second shift valve 23 introduced to the third control valve unit SL3 depending on an the amount of the electric power thereof, the third control valve unit SL3 generates controlled hydraulic pressure, and such generated controlled hydraulic pressure is outputted from the output port Ou. When the output pressure (pressure PL or pressure R) from the fourth switching circuit 23j of the second shift valve 23 is introduced through the supply port Su of the third control valve unit SL3, at the same time output pressure (pressure D or pressure R) of the third switching circuit 24g of the third shift valve 24 is introduced through the drain port Dr of the third control valve unit SL3, the third control valve unit SL3 outputs line pressure not depending on whether the third control valve unit SL3 is energized or de-energized. The output pressure (pressure SL3) of the third control valve unit SL3 is supplied to the third friction clutch C3, the third hydraulic switch SW3, the second shuttle valve SB2 and a third hydraulic chamber 29f of the second fail valve 29. The third control valve unit SL3 employs a normal high type (NH) configuration in which maximum pressure SL3 is outputted in a de-energized state, and SL2 pressure, which is decreased as the electric current increases, is outputted in the energized state. The output port Ou of the third control valve unit SL3 is connected to the supply port Su of the third control valve unit SL3 in the de-energized state.

The fourth control valve unit SL4 is a control valve unit for controlling the first friction brake B1 and is composed of an integrated combination of a linear solenoid valve and a spool valve. The fourth control valve unit SL4 may include a linear solenoid valve and a spool valve separately. The fourth control valve unit SL4 introduces output pressure (pressure D) from the second fail valve 29 through the supply port Su thereof. At this point, on the basis of the output pressure (pressure D) of the second fail valve 29 introduced to the fourth control valve unit SL4 depending on an the amount of the electric power thereof, the fourth control valve unit SL4 generates controlled hydraulic pressure (pressure SL4), and such controlled hydraulic pressure (pressure SL4) is outputted. When the output pressure (pressure D) from the second fail valve 29 is introduced through the supply port Su of the fourth control valve unit SL4, at the same time output pressure (pressure D) of the sixth switching circuit 24j of the third shift valve 24 is introduced through the drain port Dr of the fourth control valve unit SL4, the fourth control valve unit SL4 outputs line pressure not depending on whether the fourth control valve unit SL4 is energized or de-energized. The pressure SL4 is supplied to the first friction brake B1, the fourth hydraulic switch SW4, and the second shuttle valve SB2. The fourth control valve unit SL4 employs a normal low type (NL) configuration in which pressure SL4 is not outputted in a de-energized state, and SL4 pressure, which is increased as the electric current increases, is outputted in the energized state. The output port Ou of the fourth control valve unit SL4 is connected to the drain port Dr of the fourth control valve unit SL4 in the de-energized state.

The LU control valve unit SLU is a control valve unit for controlling the lock-up clutch LU and is composed of an integrated combination of a linear solenoid valve and a spool valve. LU control valve unit SLU may include a linear solenoid valve and a spool valve. The LU control valve unit SLU introduces output pressure (pressure PL) of the second switching circuit 24f of the third shift valve 24 through the supply port Su. At this point, on the basis of the output pressure (pressure PL) of the second switching circuit 24f of the third shift valve introduced to LU control valve unit SLU depending on an the amount of the electric power thereof, the LU control valve unit SLU generates controlled hydraulic pressure (pressure SLU). Such controlled hydraulic pressure (pressure SLU) is outputted. The pressure SLU is supplied to the lock-up clutch LU and the LU relay valve 30. The LU control valve unit SLU employs a normal low type (NL) configuration in which pressure SLU is not outputted in a de-energized state, and SLU pressure, which is increased as the electric current increases, is outputted in the energized state. In the de-energized state, the output port Ou of the LU control valve unit SLU is connected to the drain port Dr of the LU control valve unit SLU (exhaust circuit EX).

The manual valve 21 switches the hydraulic pressure circuit in conjunction with the driving range selected by a driver's operation of the operation lever (manual lever; not shown). The manual valve 21 includes a spool 21a sliding within a casing in conjunction with the operation of the operation lever. When the operation lever is selected to the drive range, the manual valve 21 outputs pressure PL, which is inputted through the pressure PL port thereof, as pressure D from the pressure D port thereof. When the operation lever is selected to the reverse range, the manual valve 21 outputs the pressure PL, which is inputted through the pressure PL port, as pressure R from the pressure R port thereof. The output pressure (pressure D) from the pressure D port of the manual valve 21 is supplied to the supply port Su of the second control valve unit SL2, a first switching circuit 22g of the first shift valve 22, a first switching circuit 23g of the second shift valve 23, a fifth switching circuit 23k, a fourth switching circuit 24h of the third shift valve 24, and the fifth switching circuit 24i. The output pressure (pressure R) from the pressure R port of the manual valve 21 is supplied to a second switching circuit 22h of the first shift valve 22, a second hydraulic chamber 23e of the second shift valve 23, a first shuttle valve SB1, a seventh switching circuit 24k of the third shift valve 24, the fourth shuttle valve SB4, and the third shuttle valve SB3.

The first shift valve 22 is a switch valve for switching an oil passage and includes a first spool 22a, a second spool 22b, a spring 22c, a first hydraulic chamber 22d, a second hydraulic chamber 22e, and third hydraulic chamber 22f within a valve body (not shown) thereof. The first spool 22a is provided so as to be slidable within the valve body (not shown). The second spool 22b is provided so as to be slidable within the valve body (not shown). Specifically, the first spool 22a is provided at one end portion of the spring 22c, and the second spool 22b is provided at the other end portion of the spring 22c. In this configuration, the spring 22c is positioned within the second hydraulic chamber 22e so as to bias the first spool 22a toward the first hydraulic chamber 22d and bias the second spool 22b toward the third hydraulic chamber 22f. Once a signal pressure from the first on/off solenoid valve S1 is introduced into the first hydraulic chamber 22d, the first spool 22a is operated in a manner where it is pressed toward the third hydraulic chamber 22f. The second hydraulic chamber 22e is connected to the drain port Dr (exhaust circuit; EX). Once hydraulic pressure (pressure C2) applied to the second friction clutch C2 is introduced into the third hydraulic chamber 22f, the second spool 22b is operated in a manner where it is pressed toward the first hydraulic chamber 22d by means of the pressure C2. The first spool 22a slides toward the third hydraulic chamber 22f (“x”) when a pressing force by the hydraulic pressure of the first hydraulic chamber 22d is higher than a total force of the biasing force of the spring 22c and a pressing force of the hydraulic pressure of the third hydraulic chamber 22f. The first spool 22a slides toward the first hydraulic chamber 22d (“∘”) when the pressing force by the hydraulic pressure of the first hydraulic chamber 22d is lower than the total force of the biasing force of the spring 22c and the pressing force of the hydraulic pressure of the third hydraulic chamber 22f. The first shift valve 22 includes a first switching circuit 22g for switching the oil passage. Specifically, in the “x” state, the first switching circuit 22g establishes a communication among the first switching circuit 23g of the second shift valve 23, the second switching circuit 23h of the second shift valve 23 and the pressure D port of the manual valve 21, and in the “∘” state, the first switching circuit 22g establishes a communication among the first switching circuit 23g of the second shift valve 23, the second switching circuit 23h of the second shift valve 23 and the exhaust port (EX). The first shift valve 22 further includes a second switching circuit 22h for switching the oil passage. Specifically, in the “x” state, the second switching circuit 22h establishes a communication between the fourth switching circuit 23j of the second shift valve 23 and the pressure R port of the manual valve 21, and in the “∘” state, the second switching circuit 22h establishes a communication among the fourth switching circuit 23j of the second shift valve 23, the fifth switching circuit 24i of the third shift valve 24, and the input port In of the second fail valve 29. The first shift valve 22 further includes a third switching circuit 22i for switching the oil passage. Specifically, in the “∘” state, the third switching circuit 22i establishes a communication between the sixth switching circuit 231 of the second shift valve 23 and the exhaust port (EX), and in the “x” state, the third switching circuit 22i establishes a communication between the sixth switching circuit 231 of the second shift valve 23 and the output port Ou of the second control valve unit SL2. The first shift valve 22 further includes a fourth switching circuit 22j for switching the oil passage. Specifically, in the “x” state, the fourth switching circuit 22j establishes a communication among the second friction clutch C2, second hydraulic chamber 28f of the first fail valve 28 and the exhaust port (EX), and in the “∘” state, the fourth switching circuit 22j establishes a communication among the second friction clutch C2, second hydraulic chamber 28f of the first fail valve 28 and the output port Ou of the second control valve unit SL2. The first shift valve 22 further includes a fifth switching circuit 22k for switching the oil passage. Specifically, in the “∘” state, the fifth switching circuit 22k establishes a communication between the drain port Dr of the second control valve unit SL2 and the fifth switching circuit 23k of the fifth switching circuit 23k, and in the “x” state, the fifth switching circuit 22k establishes a communication between the drain port Dr of the second control valve unit SL2 and the exhaust port (EX). An orifice and a check valve are provided at the oil passage between the second switching circuit 22h of the first shift valve 22 and the fourth switching circuit 23j of the second shift valve 23.

The second shift valve 23 is a switching valve for switching the oil passage and includes a first spool 23a, a second spool 23b, a spring 23c, a first hydraulic chamber 23d, a second hydraulic chamber 23e and a third hydraulic chamber 23f within a valve body (not shown). The first spool 23a is provided so as to be slidable within the valve body (not shown). The second spool 23b is provided so as to be slidable within the valve body (not shown). Specifically, the first spool 23a is provided at one end portion of the spring 23c, and the second spool 23b is provided at the other end portion of the spring 23c. In this configuration, the spring 23c is positioned within the second hydraulic chamber 23e so as to bias the first spool 23a toward the first hydraulic chamber 23d and to bias the second spool 23b toward the third hydraulic chamber 23f. Once a signal pressure from the second on/off solenoid valve S2 is introduced into the first hydraulic chamber 23d, the first spool 23a is operated so as to be pressed toward the third hydraulic chamber 23f. Once the pressure R from the pressure R port of the manual valve 21 is inputted into the second hydraulic chamber 23e, the first spool 23a is operated so as to be pressed toward the first hydraulic chamber 23d, and the second spool 23b is operated so as to be pressed toward the third hydraulic chamber 23f. Once hydraulic pressure from the sixth switching circuit 231 of the second shift valve 23 is introduced into the third hydraulic chamber 23f, the second spool 23b is operated so as to be pressed toward the first hydraulic chamber 23d. The first spool 23a slides toward the third hydraulic chamber 23f (“x”) when a pressing force by the hydraulic pressure of the first hydraulic chamber 23d is higher than a total force of the biasing force of the spring 23c and a pressing force of the hydraulic pressure of the second hydraulic chamber 23e, or a total force of the biasing force of the spring 23c and a pressing force of the hydraulic pressure of the third hydraulic chamber 23f. The first spool 23a slides toward the first hydraulic chamber 23d (“∘”) when a pressing force by the hydraulic pressure of the first hydraulic chamber 23d is lower than a total force of the biasing force of the spring 23c and a pressing force of the hydraulic pressure of the second hydraulic chamber 23e, or a total force of the biasing force of the spring 23c and a pressing force of the hydraulic pressure of the third hydraulic chamber 23f. The second shift valve 23 includes a first switching circuit 23g for switching the oil passage. Specifically, in the “x” state, the first switching circuit 23g establishes a communication between an input port In of the first fail valve 28 and the first switching circuit 22g of the first shift valve 22, and in the “∘” state, the first switching circuit 23g establishes a communication between the input port In of the first fail valve 28 and the pressure D port of the manual valve 21. The second shift valve 23 further includes a second switching circuit 23h for switching the oil passage. Specifically, in the “x” state, the second switching circuit 23h establishes a communication between the release port Re of the first fail valve 28 and the drain port Dr of the first control valve unit SL1, and a communication between a N-D accumulator 26 and the first switching circuit 22g of the first shift valve 22, and in the “∘” state, the second switching circuit 23h establishes a communication between the release port Re of the first fail valve 28 and the drain port Dr of the first control valve unit SL1, and a communication between the N-D accumulator 26 and the fourth switching circuit 24h of the third shift valve 24. The second shift valve 23 further includes a third switching circuit 23i for switching the oil passage. Specifically, in the “∘” state, the third switching circuit 23i establishes a communication between the first shuttle valve SB1 and the first switching circuit 22g of the first shift valve 22, and in the “x” state, the third switching circuit 23i establishes a communication between the first shuttle valve SB1 and the exhaust port (EX). The second shift valve 23 further includes a forth switching circuit 23j for switching the oil passage. Specifically, in the “x” state, the fourth switching circuit 23j establishes a communication between the supply port Su of the third control valve unit SL3 and the first switching circuit 24e of the third shift valve 24, and in the “∘” state, the fourth switching circuit 23j establishes a communication between the supply port Su of the third control valve unit SL3 and the second switching circuit 22h of the first shift valve 22. The second shift valve 23 further includes a fifth switching circuit 23k for switching the oil passage. Specifically, in the “x” state, the fifth switching circuit 23k establishes a communication among the fifth switching circuit 22k of the first shift valve 22, the sixth switching circuit 24j of the third shift valve 24 and the pressure D port of the manual valve 21, and in the “∘” state, the fifth switching circuit 23k establishes a communication among the fifth switching circuit 22k of the first shift valve 22, the sixth switching circuit 24j of the third shift valve 24 and the exhaust port (EX). The second shift valve 23 further includes sixth switching circuit 231 for switching the oil passage. Specifically, in the “∘” state, the sixth switching circuit 231 establishes a communication among the third hydraulic chamber 23f of the second shift valve 23, the fourth shuttle valve SB4 and the third switching circuit 22i of the first shift valve 22, and in the “x” state, the sixth switching circuit 231 establishes a communication among the third hydraulic chamber 23f of the second shift valve 23, the fourth shuttle valve SB4 and the exhaust port (EX). An orifice and a check valve are provided at the oil passage between the first switching circuit 23g of the second shift valve 23 and the pressure D port of the manual valve 21. Further, another orifice and a check valve are provided at the oil passage between the second switching circuit 23h of the second shift valve 23 and the drain port Dr of the first control valve unit SL1.

The third shift valve 24 is a switch valve for switching a flow path and includes a spool 24a, a spring 24b, a first hydraulic chamber 24c, a second hydraulic chamber 24d within a valve body (not shown). The spool 24a is provided so as to be slidable within the valve body (not shown). The spring 24b is provided within the second hydraulic chamber 24d in order to bias the spool 24a toward the first hydraulic chamber 24c. Once a signal pressure from the third on/off solenoid valve S3 is introduced into the first hydraulic chamber 24c, the spool 24a is operated so as to be pressed toward the second hydraulic chamber 24d. The second hydraulic chamber 24d is connected to the drain port Dr (exhaust circuit; EX). The spool 24a slides toward the second hydraulic chamber 24d (the “x” state) when a pressing force by the hydraulic pressure of the first hydraulic chamber 24c is higher than the biasing force of the spring 24b. The spool 24a slides toward the first hydraulic chamber 24c (the “∘” state) when a pressing force by the hydraulic pressure of the first hydraulic chamber 24c is lower than the biasing force of the spring 24b. The third shift valve 24 includes a first switching circuit 24e for switching the oil passage. Specifically, in the “x” state, the first switching circuit 24e establishes a communication between the fourth switching circuit 23j of the second shift valve 23 and the pressure PL port, and in the “∘” state, the first switching circuit 24e establishes a communication between the fourth switching circuit 23j of the second shift valve 23 and the exhaust port (EX). The third shift valve 24 further includes a second switching circuit 24f for switching the oil passage. Specifically, in the “x” state, the second switching circuit 24f establishes a communication between the supply port Su of the LU control valve unit SLU and the exhaust port (EX), and in the “∘” state, the second switching circuit 24f establishes a communication between the supply port Su of the LU control valve unit SLU and the pressure PL port. The third shift valve 24 further includes a third switching circuit 24g for switching the oil passage. Specifically, in the “∘” state, the third switching circuit 24g establishes a communication among the drain port Dr of the third control valve unit SL3, a N-R accumulator 27 and the exhaust port (EX), and in the “x” state, the third switching circuit 24g establishes a communication among the drain port Dr of the third control valve unit SL3, a N-R accumulator 27 and third shuttle valve SB3. The third shift valve 24 includes fourth switching circuit 24h for changing the oil passage. Specifically, in the “x” state, the fourth switching circuit 24h establishes a communication between the second switching circuit 23h of the second shift valve 23 and the pressure D port of the manual valve 21, and in the “∘” state, the fourth switching circuit 24h establishes a communication between the second switching circuit 23h of the second shift valve 23 and the exhaust port (EX). The third shift valve 24 further includes a fifth switching circuit 24i for switching the oil passage. Specifically, in the “x” state, the fifth switching circuit 24i establishes a communication among the input port In of the second fail valve 29, the second switching circuit 22h of the first shift valve 22 and the exhaust port (EX), and in the “∘” state, the fifth switching circuit 24i establishes a communication among the input port In of the second fail valve 29, the second switching circuit 22h of the first shift valve 22 and the pressure D port of the manual valve 21. The third shift valve 24 further includes a sixth switching circuit 24j for switching the oil passage. Specifically, in the “∘” state, the sixth switching circuit 24j establishes a communication among the release port Re of the second fail valve 29, the drain port Dr of the fourth control valve unit SL4, the fifth switching circuit 23k of the second shift valve 23, and the third shuttle valve SB3, and in the “x” state, the sixth switching circuit 24j establishes a communication among the release port Re of the second fail valve 29, the drain port Dr of the fourth control valve unit SL4 and the exhaust port (EX). The third shift valve 24 further includes a seventh switching circuit 24k for switching the oil passage. Specifically, in the “x” state, the seventh switching circuit 24k establishes a communication between the second friction brake B2S and the first shuttle valve SB1, and in the “∘” state, the seventh switching circuit 24k establishes a communication between the second friction brake B2S and the pressure R port of the manual valve 21. An orifice and a check valve are provided at the oil passage among the third switching circuit 24g of the third shift valve 24 and the drain port Dr of the third control valve unit SL3. An orifice and a check valve are provided at the oil passage between the seventh switching circuit 24k of the third shift valve 24 and the first shuttle valve SB1. An orifice and a check valve are provided at the oil passage between the seventh switching circuit 24k of the third shift valve 24 and the second friction brake B2S.

The first on/off solenoid valve S1 changes the operation of the first spool 22a of the first shift valve 22 by switching between an energized state and a de-energized state. Specifically, the first on/off solenoid valve S1 has a normal high type (NH) configuration, and in the de-energized state, a signal pressure is supplied to the first shift valve 22, and in the energized state a signal pressure is not supplied to the first shift valve 22.

The second on/off solenoid valve S2 changes the operation of the first spool 23a of the second shift valve 23 by switching between an energized state and a de-energized state.

Specifically, the second on/off solenoid valve S2 has a normal high type (NH) configuration, and in a de-energized state, a signal pressure is supplied to the second shift valve 23, and in the energized state, a signal pressure is not supplied to the second shift valve 23.

The third on/off solenoid valve S3 changes the operation of the first spool 24a of the third shift valve 24 by switching between an energized state and a de-energized state. The third on/off solenoid valve S3 has a normal high type (NH) configuration, and in a de-energized state, a signal pressure is supplied to the third shift valve 24, and in the energized state, a signal pressure is not supplied to the third shift valve 24.

D-N accumulator 25, provided at the oil passage between the supply port Su of the first control valve unit SL1 and the first fail valve 28, serves as a buffering device for absorbing hydraulic shock caused by changing the driving range from the drive range to the neutral range. N-D accumulator 26, provided at the oil passage between the drain port Dr of the first control valve unit SL1 and the second switching circuit 23h of the second shift valve 23, serves as a buffering device for absorbing hydraulic shock caused by changing the driving range from the neutral range to the drive range. N-R accumulator 27, provided at the oil passage between the drain port Dr of the third control valve unit SL3 and the third switching circuit 24g of the third shift valve 24, serves as a buffering device for absorbing hydraulic shock caused by changing the driving range from the neutral range to the reverse range.

The first fail valve 28 is a valve being capable of stopping the line pressure flowing to the supply port Su of the first control valve unit SL1. The first valve 28 includes a first spool 28a, a second spool 28b, a sleeve 28c, a spring 28d, a first hydraulic chamber 28e, a second hydraulic chamber 28f and a third hydraulic chamber 28g within a valve body (not shown). The first spool 28a is provided so as to be slidable within the valve body (not shown). The second spool 28b is provided so as to be slidable between the first spool 28a and the spring 28d within the valve body (not shown). The sleeve 28c provided at an outer peripheral surface of the second spool 28b includes a hole through which the output pressure (pressure C3 and pressure B1) of the second shuttle valve SB2 is introduced. The spring 28d is provided within the third hydraulic chamber 28g in order to bias the second spool 28b toward the first hydraulic chamber 28e. Once the pressure PL is introduced into the first hydraulic chamber 28e, the first spool 28a is operated in a manner where it is pressed toward the third hydraulic chamber 28g by means of the pressure PL. Once the hydraulic pressure (pressure C2) applied to the second friction clutch C2 is introduced into the second hydraulic chamber 28f, the first spool 28a is operated in a manner where it is pressed toward the first hydraulic chamber 28e by means of the pressure C2. Once the output pressure (pressure C3 or pressure B1) of the second shuttle valve SB2 is introduced into the third hydraulic chamber 28g, the second spool 28b is operated so as to be pressed toward the first hydraulic chamber 28e. The first spool 28a slides toward the third hydraulic chamber 28g (normal state “∘”) when a pressing force of the hydraulic pressure of the first hydraulic chamber 28e is higher than a total force of a biasing force of the spring 28d, a pressing force of the second hydraulic chamber 28f and a pressing force of the hydraulic pressure of the third hydraulic chamber 28g, and the first spool 28a slides toward the first hydraulic chamber 28e (fail state “x”) when a pressing force of the hydraulic pressure of the first hydraulic chamber 28e is lower than a total force of a biasing force of the spring 28d, a pressing force of the second hydraulic chamber 28f and a pressing force of the hydraulic pressure of the third hydraulic chamber 28g.

In the “∘” states, the first fail valve 28 outputs output pressure (pressure D), which is introduced from the first switching circuit 23g of the second shift valve 23 through the input port In, toward the supply port Su of the first control valve unit SL1 and the D-N accumulator 25 through an output port Ou (e.g., serving as an fail output port), and in the “x” state, the first fail valve 28 outputs output pressure (pressure D), which is introduced from the second switching circuit 23h of the second shift valve 23 through the release port Re, toward the supply port Su of the first control valve unit SL1 and the D-N accumulator 25 through the output port Ou.

The first fail valve 28 further introduces the output pressure (pressure D) from the first switching circuit 23g of the second shift valve 23, and the first fail valve 28 introduces the output pressure (pressure D) from the second switching circuit 24h of the second shift valve 23 through the release port Re, and at this point, the first fail valve 28 outputs line pressure not depending on whether it is the fail state or the normal state. In the “x” state, the first fail valve 28 prevents the first friction clutch C1 (first engaging element), the third friction clutch C3, first friction brake B1 and/or second friction clutch C2 (second engaging element) from interlocking (double engagement) each other. Specifically, according to the first fail valve 28, because output pressure from the third control valve unit SL3, the fourth control valve unit SL4 and/or the second control valve unit SL2 (second control valve), each corresponding to the third friction clutch C3, the first friction brake B1 and/or second friction clutch C2 (second engaging element), is inputted to the third hydraulic chamber 28g and/or the second hydraulic chamber 28f, the first spool 28a slides so as to be in the “x” state so that output pressure (pressure D) of the first switching circuit 23g from the second shift valve 23 supplied to the first fail valve 28 can be stopped. The first fail valve 28 is provided at the oil passage between the hydraulic pressure source and the supply port Su of the first control valve unit SL1 (first control valve), however, the first fail valve 28 may be provided at the oil passage between the output port Ou of the first control valve unit SL1 (first control valve) and the first friction clutch C1 (first engaging element) alternatively. The release port Re of the first fail valve 28 is connected to the drain port Dr of the first control valve unit SL1 via the oil passage. The release port Re of the first fail valve 28 is connected to the exhaust circuit (EX) through all of/at least one of the shift valves 22-24, when line pressure is supplied to the supply port Su of each of the third control valve unit SL3, the fourth control valve unit SL4 and/or the second control valve unit SL2 (second control valve). The line pressure is supplied to the release port Re of the first fail valve 28 through all of/at least one of the shift valves 22-24, when the line pressure is not supplied to the supply port Su of the third control valve unit SL3, the fourth control valve unit SL4 and/or the second control valve unit SL2 (second control valve) through all of/at least one of the shift valves 22-24, and when the shift stage is configured with the first friction clutch C1 (first engaging element). The release port Re of the first fail valve 28 is connected to the exhaust circuit (EX) through all of/at least one of the shift valves 22-24, when the line pressure is not supplied to the supply port Su of the third control valve unit SL3, the fourth control valve unit SL4 and/or the second control valve unit SL2 (second control valve) through all of/at least one of the shift valves 22-24, and when the shift stage is configured without the first friction clutch C1 (first engaging element).

The second fail valve 29 is a valve being capable of stopping the line pressure supplied to the supply port Su of the fourth control valve unit SL4. The second fail valve 29 includes a first spool 29a, a second spool 29b, a spring 29c, a first hydraulic chamber 29d, a second hydraulic chamber 29e and a third hydraulic chamber 29f within a valve body (not shown). The first spool 29a is provided so as to be slidable within the valve body (not shown). The second spool 29b is provided so as to be slidable within the valve body. Specifically, the first spool 29a is provided at one end portion of the spring 29c, and the second spool 29b is provided at the other end portion of the spring 29c. In this configuration, the spring 29c is positioned within the third hydraulic chamber 29f so as to bias the first spool 29a toward the first hydraulic chamber 20d, and bias the second spool 20b toward the third hydraulic chamber 29f. Once the pressure PL is introduced into the first hydraulic chamber 29d, the first spool 29a is pressed toward the third hydraulic chamber 29f. Once the output pressure (pressure B2L) of the fourth shuttle valve SB4 is introduced into the second hydraulic chamber 29e, the first spool 29a is pressed toward the first hydraulic chamber 29d. Once the pressure C3 is introduced into the third hydraulic chamber 29f, the second spool 29b is pressed toward the first hydraulic chamber 29d. The first spool 29a slides toward the third hydraulic chamber 29f (normal state “∘”) when a pressing force of the hydraulic pressure of the first hydraulic chamber 29d is higher than a total force of: a biasing force of the spring 29c, and a pressing force of the hydraulic pressure of the second hydraulic chamber 29e or a pressing force of the third hydraulic chamber 29f; and the first spool 29a slides toward the first hydraulic chamber 29d (fail state “x”) when a pressing force of the hydraulic pressure of the first hydraulic chamber 29d is lower than a total force of: a biasing force of the spring 29c, and a pressing force of the hydraulic pressure of the second hydraulic chamber 29e or a pressing force of the third hydraulic chamber 29f. In the “∘” states, the second fail valve 29 outputs output pressure (pressure D), which is introduced from the fifth switching circuit 24i of third shift valve 24 through the input port In, toward the supply port Su of fourth control valve unit SL4 through the output port Ou, and in the “x” state, the second fail valve 29 outputs output pressure (pressure D), which is introduced from the sixth switching circuit 24j of the third shift valve 24 through the release port Re, toward the supply port Su of fourth control valve unit SL4 through the output port Ou. The second fail valve 29 further introduces the output pressure (pressure D) from the fifth switching circuit 24i of the third shift valve 24, and the second fail valve 29 introduces the output pressure (pressure D) from the second switching circuit 24j of the third shift valve 24 through the release port Re, and at this point, the second fail valve 29 outputs line pressure not depending on the fail state or the normal state. In the “x” state, the second fail valve 29 prevents the first friction brake B1 (first engaging element) and the second friction brake B2L (second engaging element) from being interlocking (double engagement) each other. Specifically, because the output pressure from the second control valve unit SL2 (second control valve) corresponding to the second friction brake B2L (second engaging element) is inputted to the second hydraulic chamber 29e, the first spool 29a slides so as to be in the “x” state so that the output pressure supplied to the fifth switching circuit 24i of the third shift valve 24 can be stopped. The second fail valve 29 is provided at the oil passage between the hydraulic pressure source and the supply port Su of the fourth control valve unit SL4 (first control valve). However, the second fail valve 29 may be provided at the oil passage between the output port Ou of the fourth control valve unit SL4 (first control valve) and the first friction brake B1 (first engaging element) alternatively. The release port Re of the second fail valve 29 is connected to the drain port Dr of the fourth control valve unit SL4 via the oil passage. The release port Re of second fail valve 29 is connected to the exhaust circuit (EX) through all of/at least one of the shift valves 22-24, when the line pressure is supplied to the supply port Su of the second control valve unit SL2 (second control valve). The line pressure is supplied to the release port Re of the second fail valve 29 through all of/at least one of the shift valves 22-24, when the line pressure is not supplied to the supply port Su of the second control valve unit SL2 (second control valve) through all of/at least one of the shift valves 22-24, and when the shift stage is configured with the first friction brake B1 (first engaging element). The release port Re of second fail valve 29 is connected to the exhaust circuit (EX) through all of/at least one of the shift valves 22-24, when the line pressure is not supplied to the supply port of the second control valve unit SL2 (second control valve) through all of/at least one of the shift valves 22-24, and when the shift stage is configured without the first friction brake B1 (first engaging element).

Under a circumstance where the output pressure from the first control vale unit SL1 is supplied to the first hydraulic switch SW1, the first hydraulic switch SW1 is turned on. Under a circumstance where the output pressure from the second control valve unit SL2 is supplied to the second hydraulic switch SW2, the second hydraulic switch SW2 is turned on. Under a circumstance where the output pressure from the third control valve unit SL3 is supplied to the third hydraulic switch SW3, the third hydraulic switch SW3 is turned on. third

Under a circumstance where the output pressure from the fourth control valve unit SL4 is supplied to the fourth hydraulic switch SW4, the fourth hydraulic switch SW4 is turned on.

Under a circumstance where the output pressure from the LU control valve unit SLU is supplied to the LU relay valve 30, the LU relay valve 30 switches the oil passage.

Output pressure (pressure D) of the third switching circuit 23i of the second shift valve 23 and pressure R from the manual valve 21 are supplied to the first shuttle valve SB1. When the output pressure (pressure D) from the third switching circuit 23i of the second shift valve 23 is higher than the pressure R, the first shuttle valve SB1 supplies output pressure (pressure D) from the third switching circuit 23i of the second shift valve 23 to the seventh switching circuit 24k of the third shift valve 24. When the pressure R is higher than the output pressure (pressure D) from the third switching circuit 23i of the second shift valve 23, the first shuttle valve SB1 supplies the pressure R to the seventh switching circuit 24k of the third shift valve 24.

Pressure C3 and pressure B1 are supplied to the second shuttle valve SB2. When the pressure C3 is higher than the pressure B1, the second shuttle valve SB2 supplies the pressure C3 to the third hydraulic chamber 28g of the first fail valve 28. When the pressure B1 is higher than the pressure C3, the second shuttle valve SB2 supplies the pressure B1 to the third hydraulic chamber 28g of the first fail valve 28.

Output pressure (pressure D) from the fifth switching circuit 23k of the second shift valve 23 and pressure R of the manual valve 21 is supplied to the third shuttle valve SB3. When the output pressure (pressure D) from the fifth switching circuit 23k of the second shift valve 23 is higher than the pressure R, the third shuttle valve SB3 supplies the output pressure (pressure D) from the fifth switching circuit 23k of the second shift valve 23 to the third switching circuit 24g of the third shift valve 24. When the pressure R is higher than the output pressure (pressure D) from the fifth switching circuit 23k of the second shift valve 23, the third shuttle valve SB3 supplies the pressure R to the third switching circuit 24g of the third shift valve 24.

Output pressure (pressure D) from the sixth switching circuit 231 of the second shift valve 23 and pressure R from the manual valve 21 is supplied to the fourth shuttle valve SB4. When the output pressure (pressure D) from the sixth switching circuit 231 of the second shift valve 23 is higher than the pressure R, the fourth shuttle valve SB4 supplies the output pressure (pressure D) from the sixth switching circuit 231 of the second shift valve 23 to the second friction brake B2L and the second hydraulic chamber 29e of the second fail valve 29. When the pressure R is higher than the output pressure (pressure D) from the sixth switching circuit 231 of the second shift valve 23, the fourth shuttle valve SB4 supplies the pressure R to the second friction brake B2L and the second hydraulic chamber 29e of the second fail valve 29.

The fail valves 28 and 29 may not cut the supplied pressure, and may cut the flow between the engaging element and the control valve unit. Specifically, the fail valves 28 and 29 may be provided at the output port side of the control valve unit, not at the side of the supply port Su. The first fail valve 28 may not cut the pressure C1, and may cut the pressure C3.

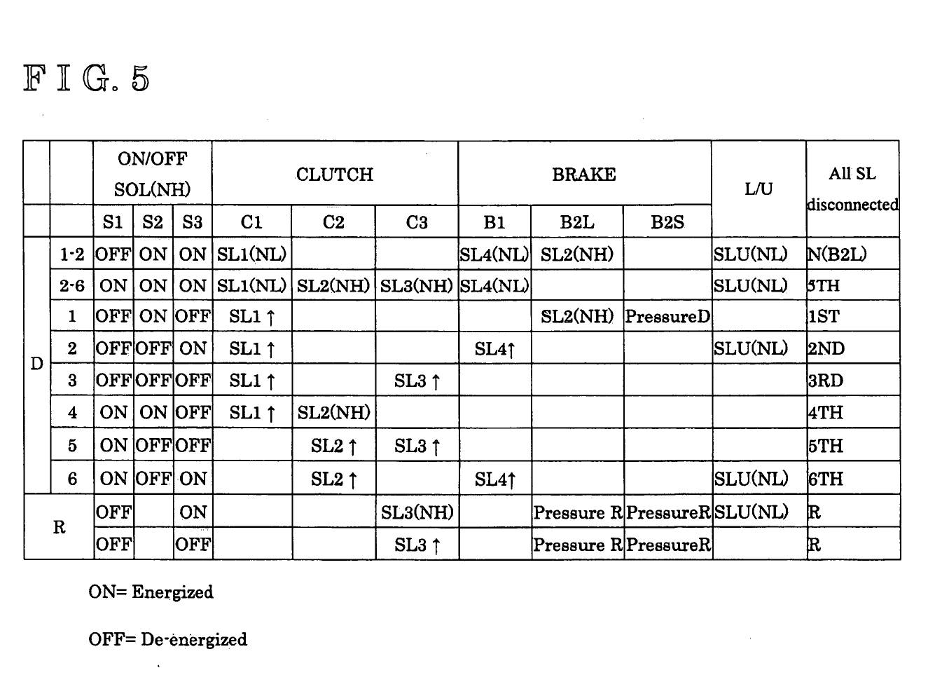

Each shifting pattern set depending on the controlling state of the hydraulic pressure control unit of the hydraulic pressure control apparatus for the automatic transmission related to the first embodiment of the present invention will be explained in detail. FIG. 5 illustrates a table indicating a relation between each shifting pattern and each driving range, which is set according to the controlling state of the hydraulic pressure control unit of the hydraulic pressure control apparatus for the automatic transmission related to the first embodiment of the present invention.

In FIG. 5, “D” indicates the drive range and “R” indicates the reverse range. The numerals places on the right of the cell of “D” indicate shift stages of the forward movement. In each columns under the cell the “ON/OFF SOL(NH)”, specifically under the cells of “S1”, “S2” and “S3”, “ON” indicates that each NH type-on/off solenoid valve is in an energized state, and “OFF” indicates that each NH type-on/off solenoid valve is in a de-energized state.

“SL1 (NL)” indicates a frictional engagement element controlled by the NL type first control valve unit SL1. “SL2 (NH)” indicates a frictional engagement element controlled by the NH type second control valve unit SL2. “SL3 (NH)” indicates a frictional engagement element controlled by the NH type third control valve unit SL3. “SL4 (NL)” indicates a frictional engagement element controlled by the NL type fourth control valve unit SL4. “SLU (NL)” indicates a frictional engagement element controlled by the NL type LU control valve unit SLU. Each “SL1↑”, “SL2↑”, “SL3↑” and “SL4↑” indicates a frictional engagement element engaged by means of line pressure supplied from each corresponding control valve unit.

Further, “All SL disconnected” indicates that the first control valve unit SL1, the second control valve unit SL2, the third control valve unit SL3, the fourth control valve unit SL4 and the LU control valve unit SLU are all disconnected.

“N (B2L)” indicates a neutral state in which only the second friction brake B2L is in an engaged state.

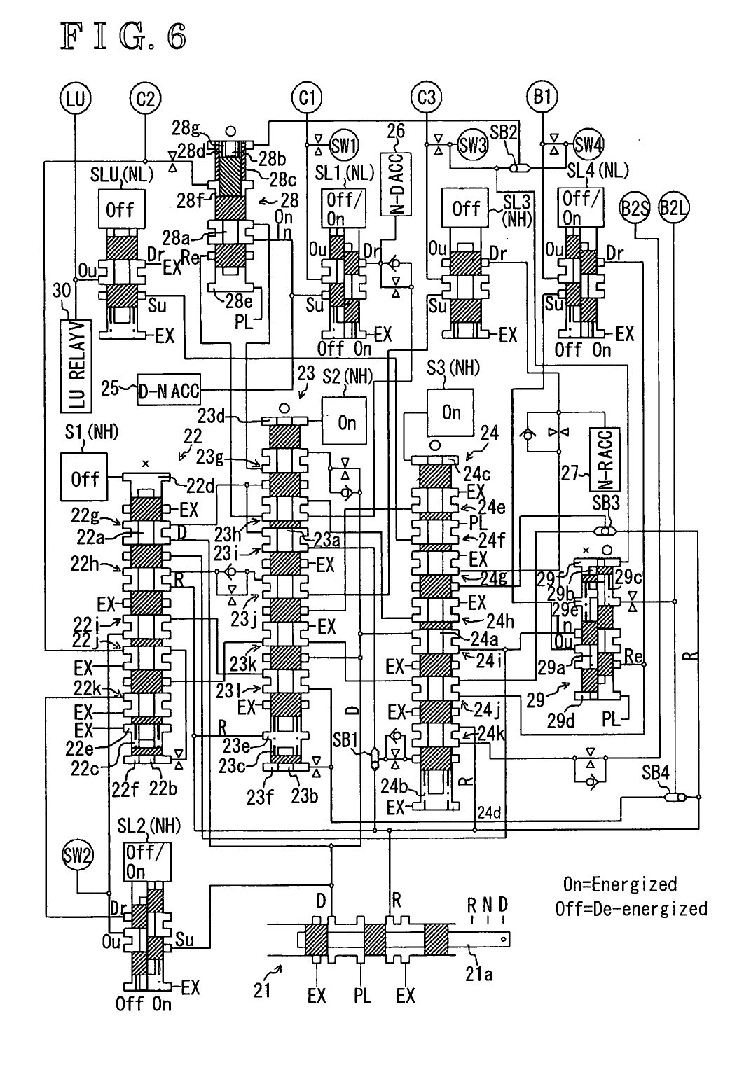

Operations related to the drive range will be explained below in accordance with the attached drawings. FIGS. 6-13 each illustrates a partial hydraulic pressure circuit diagram or explaining an operation of the hydraulic pressure control apparatus for the automatic transmission related to the first embodiment of the present invention.

(1-2 Shifting Mode)

The diagram illustrated in FIG. 6 indicates a 1-2 shifting mode, in which the shift stage is changed between the first shift stage and the second shift stage. As illustrated in FIG. 6, in the 1-2 shifting mode, the manual valve 21 is set to the drive range, the first on/off solenoid valve S1 (NH) is de-energized, the second on/off solenoid valve S2 (NH) is energized, the third on/off solenoid valve S3 (NH) is energized, the first shift valve 22 is in the “x” state, the second shift valve 23 is in the “∘” state, the third shift valve 24 is in the “∘” state, the first fail valve 28 is in the “∘” state, the second fail valve 29 being disengaged is in the “∘” state (B2L being engaged is in the “x” state), the first control valve unit SL1 (NL) is de-energized or energized, the second control valve unit SL2 (NH) is de-energized or energized, the third control valve unit SL3 (NH) is de-energized, the fourth control valve unit SL4 (NL) is de-energized or energized, and the LU control valve unit SLU (NL) is de-energized. In this state, pressure D is supplied to the supply port Su of the first control valve unit SL1 via the orifice, the check valve, first switching circuit 23g of the second shift valve 23, and first fail valve 28.

The drain port Dr of the first control valve unit SL1 (NL) is connected to the exhaust port (EX) via the orifice and the check valve, the second switching circuit 23h of the second shift valve 23, and the fourth switching circuit 24h of the third shift valve 24. Thus, when the first control valve unit SL1 (NL) is in the energized state, the output pressure of the first control valve unit SL1 (NL) is supplied to the first friction clutch C1 in order to establish the engagement of the first friction clutch C1. Pressure D is supplied to the supply port Su of the second control valve unit SL2 (NH). The drain port Dr of the second control valve unit SL2 (NH) is connected to the exhaust port (EX) via the fifth switching circuit 22k of the first shift valve 22. In this configuration, when the second control valve unit SL2 is in a de-energized state or an energized state, in which the supply port Su of the second control valve unit SL2 (NH) is not closed, the output pressure of the second control valve unit SL2(NH) is supplied to the second friction brake B2L via the third switching circuit 22i of the first shift valve 22, the sixth switching circuit 231 of the second shift valve 23, and fourth shuttle valve SB4 in order to establish the engagement of the second friction brake B2L. Pressure D is supplied to the supply port Su of the fourth control valve unit SL4 when the second fail valve 29 is in the “∘” state (B2L disengaged) via the sixth switching circuit 24i of the third shift valve 24 and the switching circuit of the second fail valve 29, and the fourth control valve unit SL4 (NL) is connected to the exhaust port (EX) via the switching circuit of the second fail valve 29, the sixth switching circuit 24j of the third shift valve 24 and the fifth switching circuit 23k of the second shift valve 23 when the second fail valve 29 is in the “x” state. The drain port Dr of the fourth control valve unit SL4 is connected to the exhaust port (EX) via the sixth switching circuit 24j of the third shift valve 24 and the fifth switching circuit 23k of the second shift valve 23. Thus, when the fourth control valve unit SL4 is in the energized state, and the second fail valve 29 is in the “x” state (B2L engaged), the output pressure of the fourth control valve unit SL4 (NL) is supplied to the first friction brake B1 in order to establish the engagement of the first friction brake B1. In this configuration, when the first control valve unit SL1 is energized, the second control valve unit SL2 is de-energized (or energized so as not to close the supply port Su), the fourth control valve unit SL4 is de-energized; the first shift stage can be achieved. If a first shift stage OWC is provided, when the first control valve unit SL1 is energized, the second control valve unit SL2 is energized (energized so as to close the supply port Su), the fourth control valve unit SL4 is de-energized; the first shift stage can be achieved. When the first control valve unit SL1 (NL) is energized, the second control valve unit SL2 (NH) is energized (energized so as to close the supply port Su of the second control valve unit SL2 (NH)), and the fourth control valve unit SL4 is energized; the second shift stage can be achieved. Further, when the first control valve unit SL1 (NL) is de-energized, the second control valve unit SL2 (NH) is energized (energized so as to close the supply port Su of the second control valve unit SL2 (NH)), and the fourth control valve unit SL4 is de-energized, the neutral can be achieved. In this manner, 1-2 shifting, N control, N-D shifting can be controlled by controlling the first control valve unit SL1, the second control valve unit SL2 and the fourth control valve unit SL4. In this configuration, when all of the first control valve unit SL1, the second control valve unit SL2, the third control valve unit SL3, the fourth control valve unit SL4 and the LU control valve unit SLU are disconnected, the neutral N (B2L) with only the second friction brake B2L engagement can be achieved.

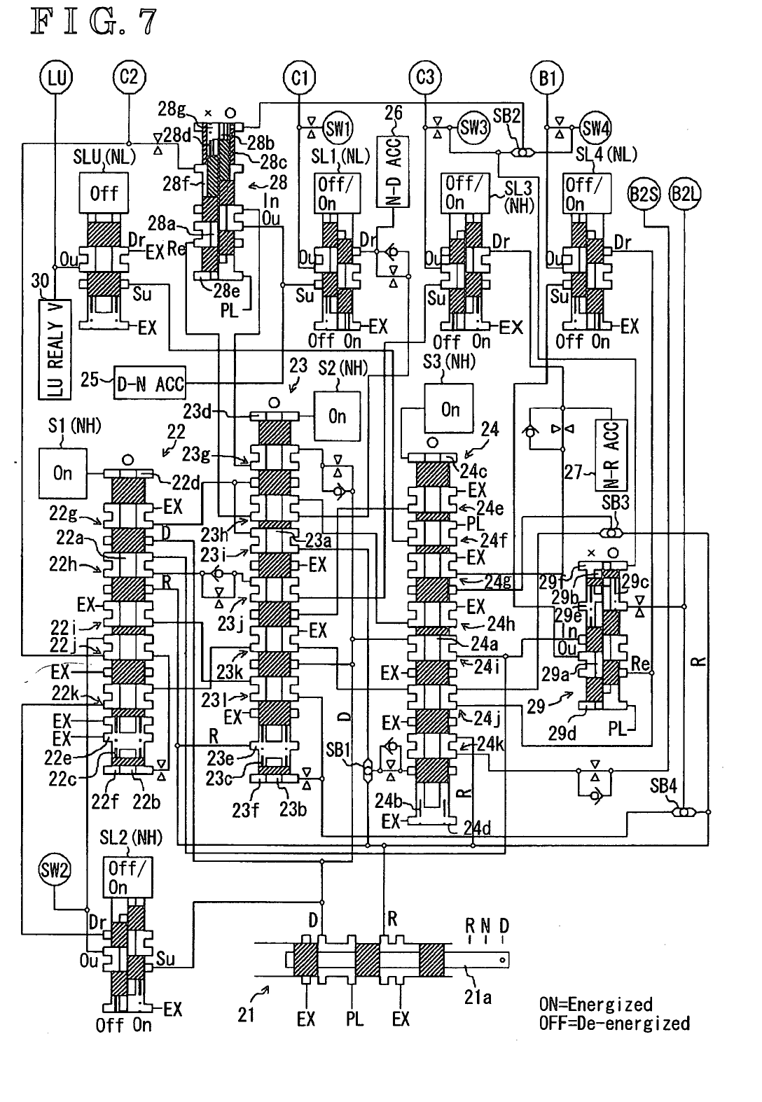

(2-6 shifting mode) The diagram illustrated in FIG. 7 indicates a 2-6 shifting mode in which the shift stage is changed among the second, third, fourth, fifth and sixth shift stages. As illustrated in FIG. 7, in the 2-6 shifting mode, the manual valve 21 is selected to the drive range, the first on/off solenoid valve S1 (NH) is energized, the second on/off solenoid valve S2 (NH) is energized, the third on/off solenoid valve S3 (NH) is energized, the first shift valve 22 is in the “∘” state, the second shift valve 23 is in the “∘” state, the third shift valve 24 is in the “∘” state, the first fail valve 28 is in the “x” state when the C2, and B1 or C3 each is in an engaged state (fifth and sixth shift stages) (“∘” state when each the C2, and B1 or C3 is in a disengaged state), the second fail valve 29 is in the “x” state when the C3 is in an engaged state (third and fifth shift stage) (in the “∘” state when the C3 is in a disengaged state), the first control valve unit SL1 (NL) is de-energized or energized, the second control valve unit SL2 (NH) is de-energized or energized, the third control valve unit SL3 (NH) is de-energized or energized, the fourth control valve unit SL4 (NL) is de-energized or energized, the LU control valve unit SLU (NL) is de-energized (may be energized). In this state, when the first fail valve 28 is in the “∘” state, pressure D is supplied to the supply port Su of the first control valve unit SL1(NL) via the orifice, the check valve, the first switching circuit 23g of the second shift valve 23, and the switching circuit of the first fail valve 28, and when the first fail valve 28 is in the “x” state, the first control valve unit SL1 is connected to the exhaust port (EX) via the switching circuit of the first fail valve 28, the second switching circuit 23h of the second shift valve 23, and the fourth switching circuit 24h of the third shift valve 24. The drain port Dr of the first control valve unit SL1(NL) is connected to the exhaust port (EX) via the orifice, the check valve, the second switching circuit 23h of the second shift valve 23, and the fourth switching circuit 24h of the third shift valve 24. In this configuration, when the first control valve unit SL1 (NL) is in the energized state, and the first fail valve 28 is in the “∘” state, the output pressure of the first control valve unit SL1 (NL) is supplied to the first friction clutch C1 in order to establish the engagement of the first friction Clutch C1. Further, pressure D is supplied to the supply port Su of the second control valve unit SL2 (NH). The drain port Dr of the second control valve unit SL2 is connected to the exhaust port (EX) via the fifth switching circuit 22k of the first shift valve 22 and the fifth switching circuit 23k of the second shift valve 23. In this configuration, when the second control valve unit SL2 (NH) is in the de-energized state or in the energized state so as not to close the supply port Su of the second control valve unit SL2 (NH), the output pressure of the second control valve unit SL2(NH) is supplied to the second friction clutch C2 via the fourth switching circuit 22j of the first shift valve 22 in order to establish the engagement of the second friction clutch C2. Further, the pressure D is supplied to the supply port Su of the third control valve unit SL3 (NH) via the fifth switching circuit 24i of the third shift valve 24, the second switching circuit 22h of the first shift valve 22, the orifice, the check valve, and the fourth switching circuit 23j of the second shift valve 23. The drain port Dr of the third control valve unit SL3 (NH) is connected to the exhaust port (EX) via the orifice, the check valve, and the third switching circuit 24g of the third shift valve 24. In this configuration, when the third control valve unit SL3 (NH) is in the de-energized state or the energized state so as not to close the supply port Su of the second control valve unit SL2 (NH), the output pressure of the third control valve unit SL3 (NH) is supplied to the third friction clutch C3 so as to establish the engagement of the third friction clutch C3. When the second fail valve 29 is in the “∘” state, the pressure D is supplied to the supply port Su of the fourth control valve unit SL4 (NL) via the sixth switching circuit 24i of the third shift valve 24 and the switching circuit of the second fail valve 29; and when the second fail valve 29 is in the “x” state, the fourth control valve unit SL4 (NL) is connected to the exhaust port (EX) via the switching circuit of the second fail valve 29, the sixth switching circuit 24j of the third shift valve 24 and the fifth switching circuit 23k of the second shift valve 23. The drain port Dr of the fourth control valve unit SL4 (NL) is connected to the exhaust port (EX) via the sixth switching circuit 24j of the third shift valve 24 and the fifth switching circuit 23k of the second shift valve 23. In this configuration, when the fourth control valve unit SL4 is in the energized state, the output pressure of SL4 is supplied to the first friction brake B1 so as to establish the engagement of the first friction brake B1. Thus, when the first control valve unit SL1 (NL) is energized, the second control valve unit SL2 (NH) is energized (energized so as to close the supply port Su), the third control valve unit SL3 (NH) is energized (energized so as to close the supply port Su), and the fourth control valve unit SL4 (NL) is energized; the second shift stage can be achieved. Further, when the first control valve unit SL1 (NL) is energized, the second control valve unit SL2 (NH) is energized (energized so as to close the supply port Su), the third control valve unit SL3 (NH) is de-energized (or energized so as not to close the supply port Su), and the fourth control valve unit SL4 (NL) is de-energized; the third shift stage can be achieved. Furthermore, when the first control valve unit SL1 (NL) is energized, the second control valve unit SL2 (NH) is de-energized (or energized so as not to close the supply port Su), the third control valve unit SL3 (NH) is energized (energized so as to close the supply port Su), and the fourth control valve unit SL4 (NL) is de-energized; the fourth shift stage can be achieved. Furthermore, when the first control valve unit SL1 (NL) is de-energized, the second control valve unit SL2 (NH) is de-energized (or energized so as not to close the supply port Su), the third control valve unit SL3 (NH) is de-energized (or energized so as not to close the supply port Su), and the fourth control valve unit SL4 (NL) is de-energized; the fifth shift stage can be achieved. Furthermore, when the first control valve unit SL1 (NL) is de-energized, the second control valve unit SL2 (NH) is de-energized (or energized so as not to close the supply port Su), the third control valve unit SL3 (NH) is energized (energized so as to close the supply port Su), and the fourth control valve unit SL4 (NL) is energized; the sixth shift stage can be achieved. Furthermore, if a first shift stage OWC is provided, when the first control valve unit SL1 (NL) is energized, the second control valve unit SL2 (NH) is energized (energized so as to close the supply port Su), the third control valve unit SL3 (NH) is energized (energized so as to close the supply port Su), and the fourth control valve unit SL4 (NL) is de-energized; the first shift stage can be achieved. Thus, the 2-6 shifting and the first shift stage (OWC) can be controlled by controlling the first control valve unit SL1, the second control valve unit SL2, the third control valve unit SL3 and the fourth control valve unit SL4. In case all of the first control valve unit SL1, the second control valve unit SL2, the third control valve unit SL3, the fourth control valve unit SL4 and the LU control valve unit SLU are disconnected, the fifth shift stage can be established by engagement of the second friction clutch C2 and the third friction clutch C3. In the same manner, in case all of the first control valve unit SL1, the second control valve unit SL2, the third control valve unit SL3, the fourth control valve unit SL4 and the LU control valve unit SLU are malfunctioned while they are energized, the fifth shift stage can be established by engagement the second friction clutch C2 and the third friction clutch C3.

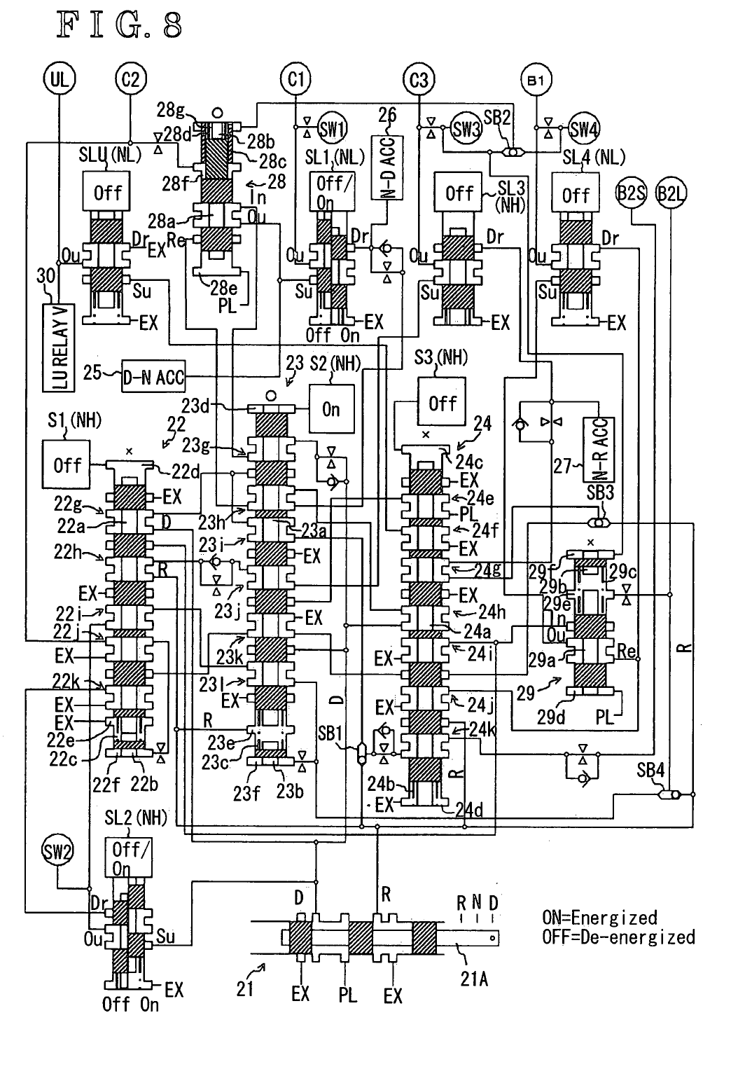

(First shift stage fixed mode) The diagram illustrated in FIG. 8 indicates a first shift stage fixed mode. As illustrated in FIG. 8, in the first shift stage fixed mode, the manual valve 21 is positioned to the drive range, the first on/off solenoid valve S1 (NH) is de-energized, the second on/off solenoid valve S2 (NH) is energized, the third on/off solenoid valve S3 (NH) is de-energized, the first shift valve 22 is in the “x” state, the second shift valve 23 is in the “∘” state, the third shift valve 24 is in the “x” state, the first fail valve 28 is in the “∘” state, the second fail valve 29 is in the “x” state, the first control valve unit SL1 (NL) is de-energized or energized, the second control valve unit SL2 (NH) is de-energized (or energized so as not to close the supply port Su), the third control valve unit SL3 (NH) is de-energized, the fourth control valve unit SL4 (NL) is de-energized, and the LU control valve unit SLU (NL) is de-energized. In this state, the pressure D is supplied to the supply port Su of the first control valve unit SL1 (NL) via the orifice, the check valve, the first switching circuit 23g of the second shift valve 23, the switching circuit of the first fail valve 28. The pressure D is supplied to the drain port Dr of the first control valve unit SL1 (NL) via the fourth switching circuit 24h of the third shift valve 24, the second switching circuit 23h of the second shift valve 23, and the orifice. In this configuration, not depending on the energized state or the de-energized state, the output pressure of the first control valve unit SL1 becomes a line pressure, and such line pressure is supplied to the first friction clutch C1 so as to establish the engagement of the first friction clutch C1. The pressure D is supplied to the supply port Su of the second control valve unit SL2 (NH). The drain port Dr of the second control valve unit SL2 is connected to the exhaust port (EX) via the fifth switching circuit 22k of the first shift valve 22. In this configuration, when the second control valve unit SL2 (NH) is in the de-energized state, and energized state so as not to close the supply port Su of the second control valve unit SL2 (NH), the output pressure of the second control valve unit SL2 is supplied to the second friction brake B2L via the third switching circuit 22i of the first shift valve 22, the sixth switching circuit 231 of the second shift valve 23 and the fourth shuttle valve SB4 so as to establish the engagement of the second friction brake B2L. Further, the pressure D of the pressure D port of the manual valve 21 is supplied to the second friction brake B2S via the first switching circuit 22g of the first shift valve 22, the third switching circuit 23i of the second shift valve 23, the first shuttle valve SB1, the orifice, the check valve, the seventh switching circuit 24k of the third shift valve 24, the orifice, and the check valve in order to establish the engagement of the second friction brake B2S. The pressure D is supplied to the release port Re of the first fail valve 28 via the fourth switching circuit 24h of the third shift valve 24 and the second switching circuit 23h of the second shift valve 23. Thus, the first shift stage can be achieved not depending on the state of the first fail valve 28. In this state, the first shift stage can be maintained even when all the first control valve unit SL1, the second control valve unit SL2, the third control valve unit SL3, the fourth control valve unit SL4 and the LU control valve unit SLU are disconnected.

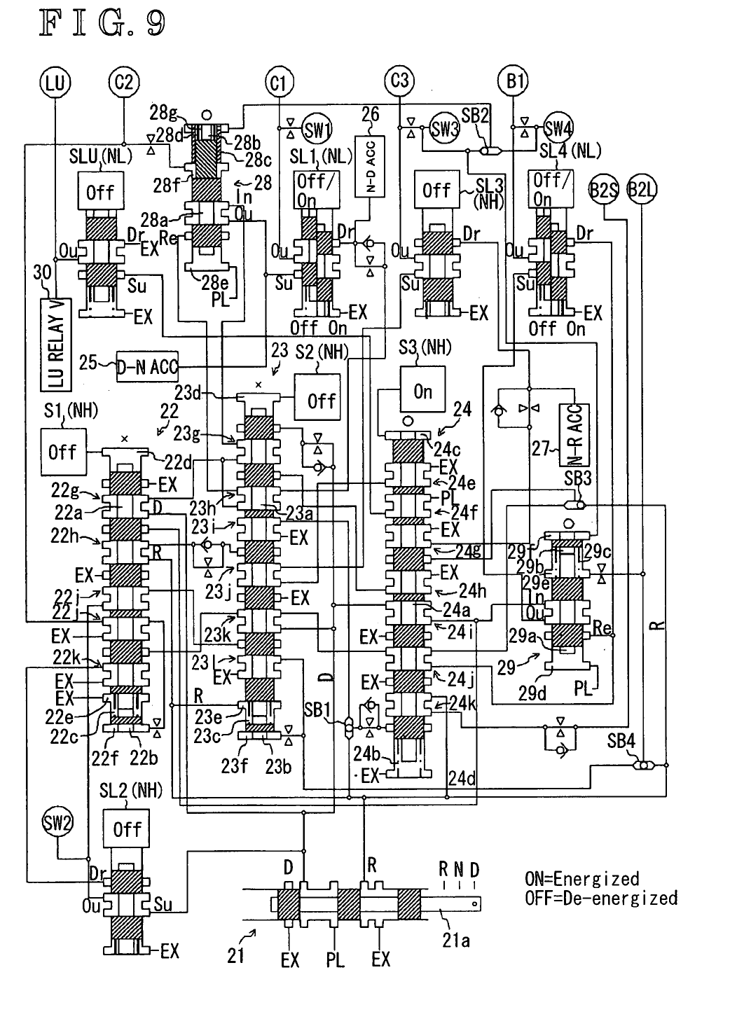

(Second shift stage fixed mode) The diagram illustrated in FIG. 9 illustrates a second shift stage fixed mode. As illustrated in FIG. 9, in the second shift stage fixed mode, the manual valve 21 is set to the drive range, the first on/off solenoid valve S1 (NH) is de-energized, the second on/off solenoid valve S2 (NH) is de-energized, the third on/off solenoid valve S3 (NH) is energized, the first shift valve 22 is in the “x” state, the second shift valve 23 is in the “x” state, the third shift valve 24 is in the “∘” state, the first fail valve 28 is in the “∘” state, the second fail valve 29 is in the “∘” state, the first control valve unit SL1 (NL) is de-energized or energized, the second control valve unit SL2 (NH) is de-energized, the third control valve unit SL3 (NH) is de-energized, the fourth control valve unit SL4 (NL) is de-energized or energized, and the LU control valve unit SLU (NL) is de-energized (may be energized). The pressure D is supplied to the drain port Dr of the first control valve unit SL1 (NL) via the first switching circuit 22g of the first shift valve 22, the second switching circuit 23h of the second shift valve 23, and the orifice. In this configuration, not depending on the energized state or the de-energized state, the output pressure of the first control valve unit SL1 (NL) becomes line pressure, and such line pressure is supplied to the first friction clutch C1 in order to establish the engagement of the first friction clutch C1. The pressure D is supplied to the supply port Su of the fourth control valve unit SL4 (NL) via the fifth switching circuit 24i of the third shift valve 24 and the switching circuit of the second fail valve 29. The pressure D is supplied to the drain port Dr of the fourth control valve unit SL4 (NL) via the fifth switching circuit 23k of the second shift valve 23 and the sixth switching circuit 24j of the third shift valve 24. In this configuration, not depending on the energized state or the de-energized, the output pressure becomes line pressure, and such line pressure is supplied to the first friction brake B1 so as to establish the engagement of the first friction brake B1. The pressure D is supplied to the release port Re of the first fail valve 28 via the first switching circuit 22g of the first shift valve 22 and the second switching circuit 23h of the second shift valve 23. The pressure D is supplied to the release port Re of the second fail valve 29 via the fifth switching circuit 23k of the second shift valve 23 and the sixth switching circuit 24j of the third shift valve 24. In this configuration, not depending on the fail valves 28 and 29, the second shift stage can be achieved. Further, even when all of the first control valve unit SL1, the second control valve unit SL2, the third control valve unit SL3, the fourth control valve unit SL4 and the LU control valve unit SLU are disconnected, the second shift stage can be maintained.

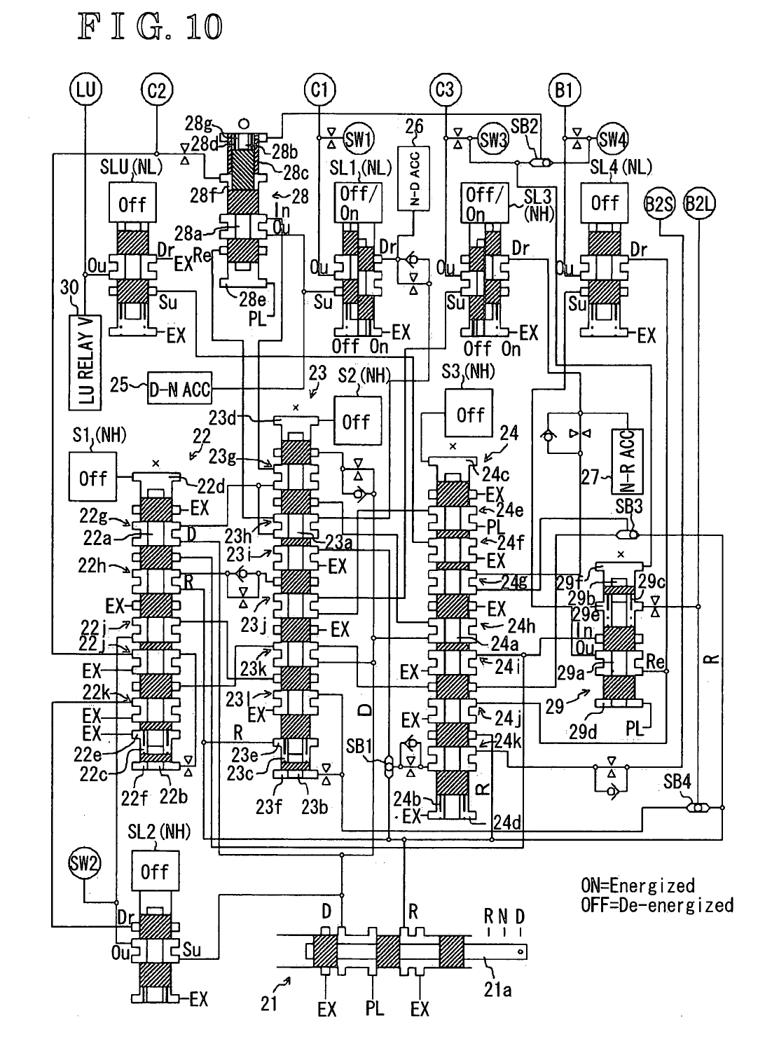

(Third shift stage fixed mode) FIG. 10 illustrates a diagram indicating a third shift stage fixed mode. As illustrated in FIG. 10, in the third shift stage fixed mode, the manual valve 21 is set to the drive range, the first on/off solenoid valve S1 (NH) is de-energized, the second on/off solenoid valve S2 (NH) is de-energized, the third on/off solenoid valve S3 (NH) is de-energized, the first shift valve 22 is in the “x” state, the second shift valve 23 is in the “x” state, the third shift valve 24 is in the “>x” state, the first fail valve 28 is in the “∘” state, the second fail valve 29 is in the “x” state, the first control valve unit SL1 (NL) is de-energized or energized, the second control valve unit SL2 (NH) is de-energized, the third control valve unit SL3 (NH) is de-energized or energized, the fourth control valve unit SL4 (NL) is de-energized, and the LU control valve unit SLU (NL) is de-energized. In this state, the pressure D is supplied to the supply port Su of the first control valve unit SL1 (NL) via the first switching circuit 22g of the first shift valve 22, the first switching circuit 23g of the second shift valve 23, and the switching circuit of the first fail valve 28. The pressure D is supplied to the drain port Dr of the first control valve unit SL1 (NL) via the first switching circuit 22g of the first shift valve 22, the second switching circuit 23h of the second shift valve 23 and the orifice. In this configuration, not depending on the energized state or the de-energized state, the output pressure of the first control valve unit SL1 (NL) becomes line pressure, and such line pressure is supplied to the first friction clutch C1 so as to establish the engagement of the first friction clutch C1. The pressure PL is supplied to the supply port Su of the third control valve unit SL3 (NH) via the first switching circuit 24e of the third shift valve 24 and the fourth switching circuit 23j of the second shift valve 23. The pressured is supplied to the drain port Dr of the third control valve unit SL3 (NH) via the fifth switching circuit 23k of the second shift valve 23, the third shuttle valve SB3 and the third switching circuit 24g of the third shift valve 24 and the orifice. In this configuration, not depending on the energized state or the de-energized state, the output pressure of the third control valve unit SL3 (NH) becomes line pressure, and such line pressure is supplied to the third friction clutch C3 in order to establish the engagement of the third friction clutch C3. The pressure D is supplied to the release port Re of the first fail valve 28 via the first switching circuit 22g of the first shift valve 22 and the second switching circuit 23h of the second shift valve 23. In this configuration, not depending on the first fail valve 28, the third shift stage can be achieved. Further, even when all of the first control valve unit SL1, the second control valve unit SL2, the third control valve unit SL3, the fourth control valve unit SL4 and the LU control valve unit SLU are disconnected, the third shift stage can be maintained.

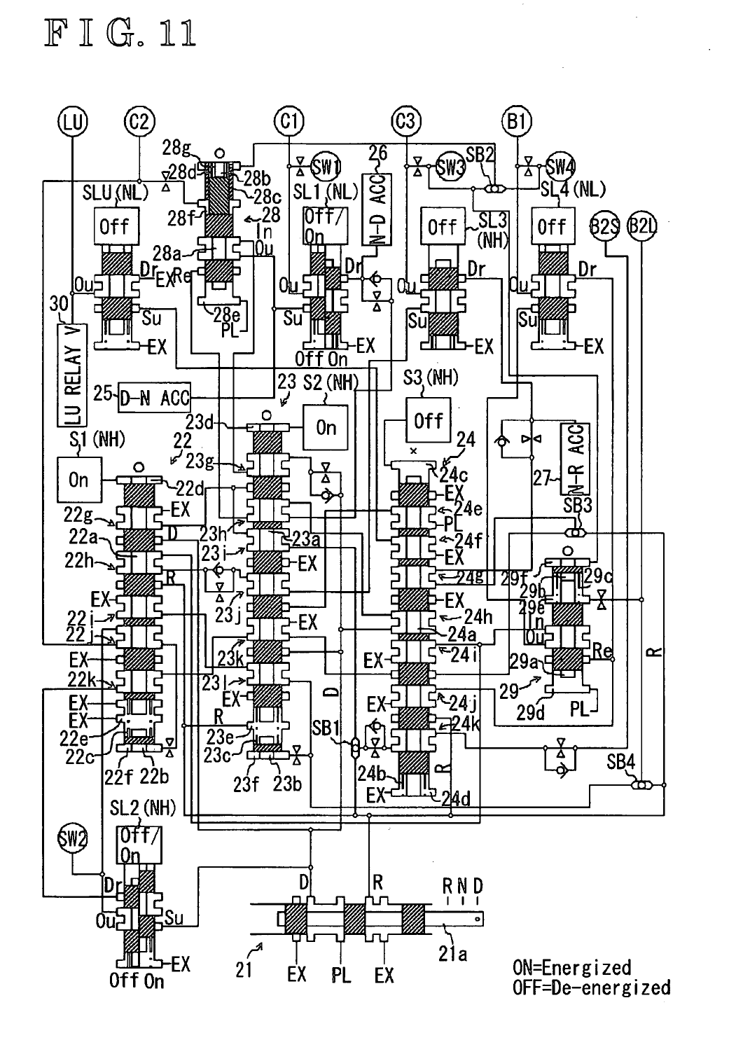

(Fourth shift stage fixed mode) FIG. 11 illustrates a diagram indicating a fourth shift stage fixed mode. As illustrated in FIG. 11, in the fourth shift stage fixed mode, the manual valve 21 is set to the drive range, the first on/off solenoid valve S1 (NH) is energized, the second on/off solenoid valve S2 (NH) is energized, the third on/off solenoid valve S3 (NH) is de-energized, the first shift valve 22 is in the “∘” state, the second shift valve 23 is in the “∘” state, the third shift valve 24 is in the “x” state, the first fail valve 28 is in the “∘” state, the second fail valve 29 is in the “∘” state, the first control valve unit SL1 (NL) is de-energized or energized, the second control valve unit SL2 (NH) is de-energized (or energized so as not to close the supply port Su), the third control valve unit SL3 (NH) is de-energized, the fourth control valve unit SL4 (NL) is de-energized, and the LU control valve unit SLU (NL) is de-energized. In this state, the pressure D is supplied to the supply port Su of the first control valve unit SL1 (NL) via the orifice, the check valve, the first switching circuit 23g of the second shift valve 23 and the switching circuit of the first fail valve 28. The pressure D is supplied to the drain port Dr of the first control valve unit SL1 (NL) via the fourth switching circuit 24h of the third shift valve 24, the second switching circuit 23h of the second shift valve 23 and the orifice. In this configuration, not depending on the energized state or the de-energized state, the output pressure of the first control valve unit SL1 becomes the line pressure, and such line pressure is supplied to the first friction clutch C1 so as to establish the engagement of the first friction clutch C1. Further, the pressure D is supplied to the supply port Su of the second control valve unit SL2 (NH). The drain port Dr of the second control valve unit SL2 (NH) is connected to the exhaust port (EX) via the fifth switching circuit 22k of the first shift valve 22 and the fifth switching circuit 23k of the second shift valve 23. In this configuration, in the energized state, the output pressure of SL2 (NH) is supplied to the second friction clutch C2 via the fourth switching circuit 22j of the first shift valve 22 so as to establish the engagement of the second friction clutch C2. Further, the pressure D is supplied to the release port Re of the first fail valve 28 via the fourth switching circuit 24h of the third shift valve 24 and the second switching circuit 23h of the second shift valve 23. Thus, not depending on the first fail valve 28, the fourth shift stage can be achieved. Further, even when all of the first control valve unit SL1, the second control valve unit SL2, the third control valve unit SL3, the fourth control valve unit SL4 and the LU control valve unit SLU are disconnected, the fourth shift stage can be maintained.

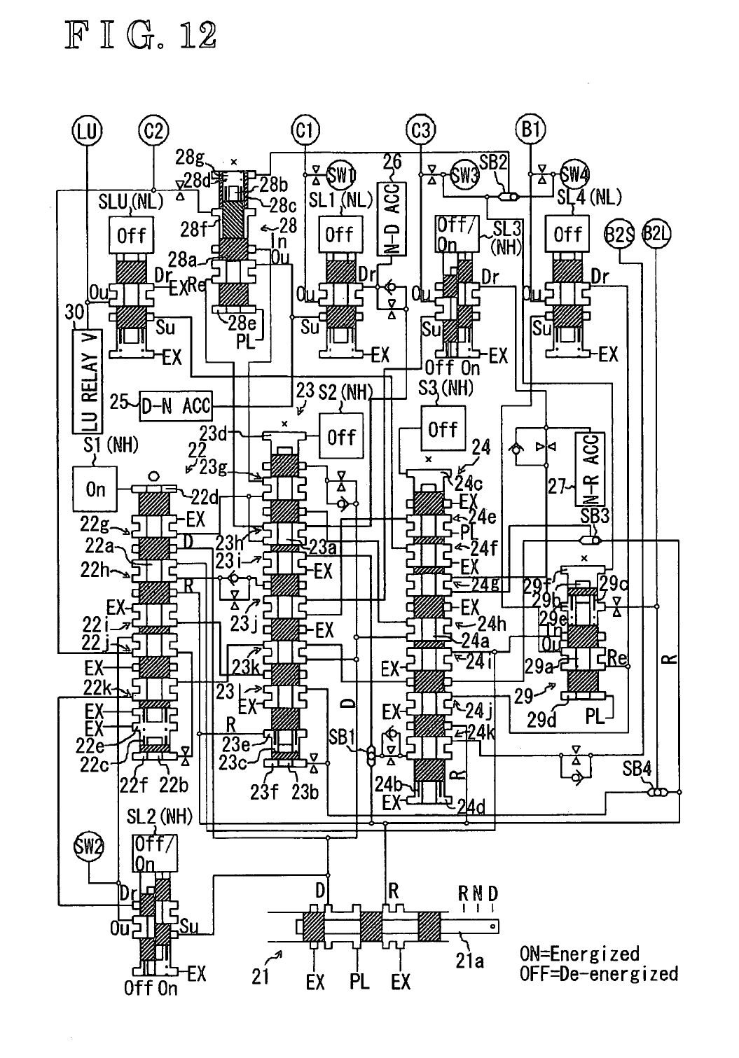

(Fifth shift stage fixed mode) FIG. 12 illustrates a diagram indicating a fifth shift stage fixed mode. As shown in FIG. 12, in the fifth shift stage fixed mode, the manual valve 21 is set to the drive range, the first on/off solenoid valve S1 (NH) is energized, the second on/off solenoid valve S2 (NH) is de-energized, the third on/off solenoid valve S3 (NH) is de-energized, the first shift valve 22 is in the “∘” state, the second shift valve 23 is in the “x” state, the third shift valve 24 is in the “x” state, the first fail valve 28 is in the “x” state, the second fail valve 29 is in the “x” state, the first control valve unit SL1 (NL) is de-energized, the second control valve unit SL2 (NH) is de-energized or energized, the third control valve unit SL3 (NH) is de-energized or energized, the fourth control valve unit SL4 (NL) is de-energized, and the LU control valve unit SLU (NL) is de-energized. In this state, the pressure D is supplied to the supply port Su of the second control valve unit SL2 (NH). The pressure D is supplied to the drain port Dr of the second control valve unit SL2 (NH) via the fifth switching circuit 23k of the second shift valve 23 and the fourth switching circuit 22j of the first shift valve 22. In this configuration, not depending on the energized state or the de-energized state, the output pressure of the second control valve unit SL2 is supplied to the second friction clutch C2 via the fourth switching circuit 22j of the first shift valve 22 so as to establish the engagement of the second friction clutch C2. Further, the pressure PL is supplied to the supply port Su of the second control valve unit SL2 (NH) via the first switching circuit 24e of the third shift valve 24 and the fourth switching circuit 23j of the second shift valve 23. The pressure D s supplied to the drain port Dr of the third control valve unit SL3 (NH) via the fifth switching circuit 23k of the second shift valve 23, the third shuttle valve SB3, the third switching circuit 24g of the third shift valve 24 and the orifice. Thus, not depending on the energized state or the de-energized state, the output pressure becomes line pressure, and such line pressure is supplied to the third friction clutch C3 so as to establish the engagement of the third friction clutch C3. In this configuration, the fifth shift stage can be achieved. Further, even when all of the first control valve unit SL1, the second control valve unit SL2, the third control valve unit SL3, the fourth control valve unit SL4 and the LU control valve unit SLU are closed, the fifth shift stage can be maintained.

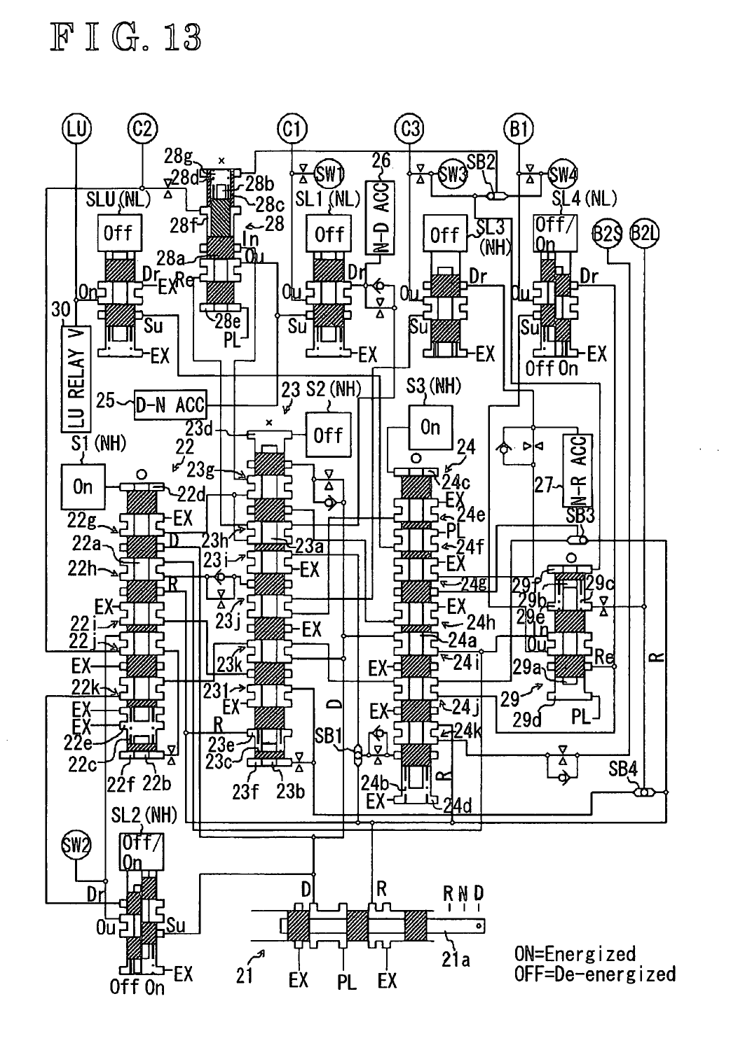

(Sixth shift stage fixed mode) FIG. 13 illustrates a diagram indicating a sixth shift stage fixed mode. As illustrated in FIG. 13, in the sixth shift stage fixed mode, the manual valve 21 is set to the drive range, the first on/off solenoid valve S1 (NH) is energized, the second on/off solenoid valve S2 (NH) is de-energized, the third on/off solenoid valve S3 (NH) is energized, the first shift valve 22 is in the “∘” state, the second shift valve 23 is in the “x” state, the third shift valve 24 is in the “∘” state, the first fail valve 28 is in the “x” state, the second fail valve 29 is in the “∘” state, the first control valve unit SL1 (NL) is de-energized, the second control valve unit SL2 (NH) is de-energized or energized, the third control valve unit SL3 (NH) is de-energized, the fourth control valve unit SL4 (NL) is de-energized or energized, and the LU control valve unit SLU (NL) is de-energized (may be energized). In this state, the pressure D is supplied to the supply port Su of the fourth control valve unit SL4(NL) via the fifth switching circuit 24i of the third shift valve 24 and the switching circuit of the, second fail valve 29. The pressure D is supplied to the drain port Dr of the fourth control valve unit SL4 (NL) via the fifth switching circuit 23k of the second shift valve 23, and the sixth switching circuit 24j of the third shift valve 24. Thus, not depending on the energized state or the de-energized state, the output pressure of the fourth control valve unit SL4 (NL) becomes line pressure, and such line pressure is supplied to the first friction brake B1 so as to establish the engagement of the first friction brake B1. The pressure D is supplied to the supply port Su of the second control valve unit SL2 (NH). The pressure D is supplied to the drain port Dr of the second control valve unit SL2 (NH) via the fifth switching circuit 23k of the second shift valve 23 and the fifth switching circuit 22k of the first shift valve 22. In this configuration, not depending on the energized state or the de-energized state, the output pressure of the second control valve unit SL2 (NH) becomes the line pressure, and such pressure is supplied to the second friction clutch C2 via the fourth switching circuit 22j of the first shift valve 22 so as to establish the engagement of the second friction clutch C2. Further, the pressure D is supplied to the release port Re of the second fail valve 29 via the fifth switching circuit 23k of the second shift valve 23 and the sixth switching circuit 24j of the third shift valve 24. In this configuration, not depending on the second fail valve 29, the sixth shift stage can be achieved. In this state, even when all of the first control valve unit SL1, the second control valve unit SL2, the third control valve unit SL3, the fourth control valve unit SL4 and the LU control valve unit SLU are disconnected, the sixth shift stage can be maintained.

Not depending on the fail valves 28 and 29, the stage for the rear movement can be established by engagements of the third friction clutch C3 and the second friction brake B2.

Thus, according to the first embodiment, in each of the 1-2 shifting mode and the 2-6 shifting mode, an interlock can be avoided by means of operations of the fail valves 28 and 29. Further, according to the first embodiment, when the fail valves 28 and 29 fail to operate properly, escaping to each fixed mode, even when the fail valves 28 and 29 are in the “x” state (fail state), the vehicle still can travel.

### EXAMPLE 1

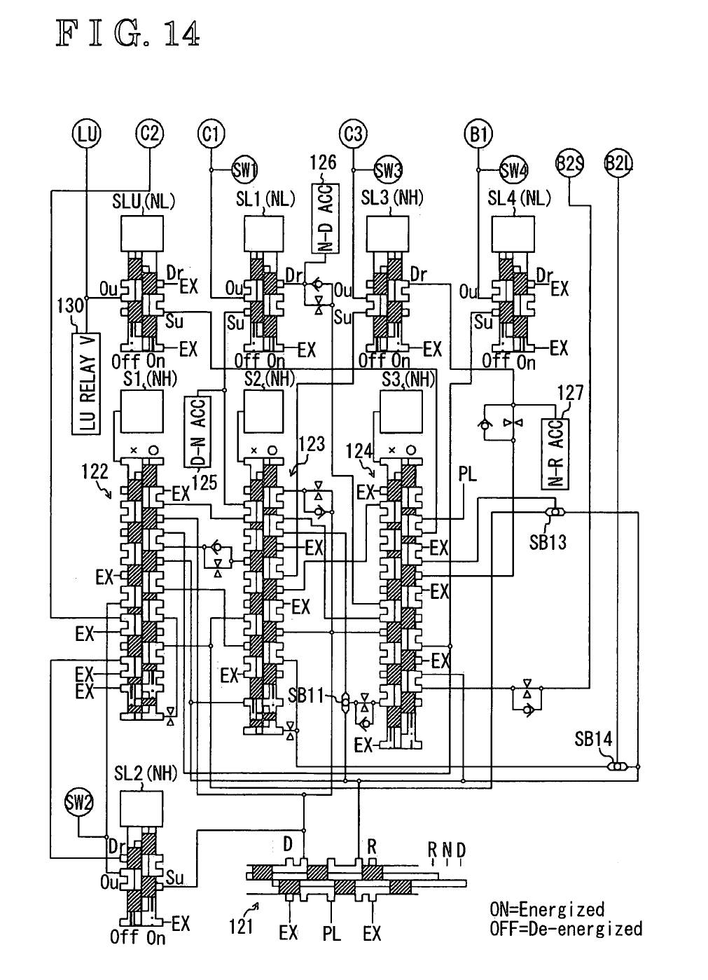

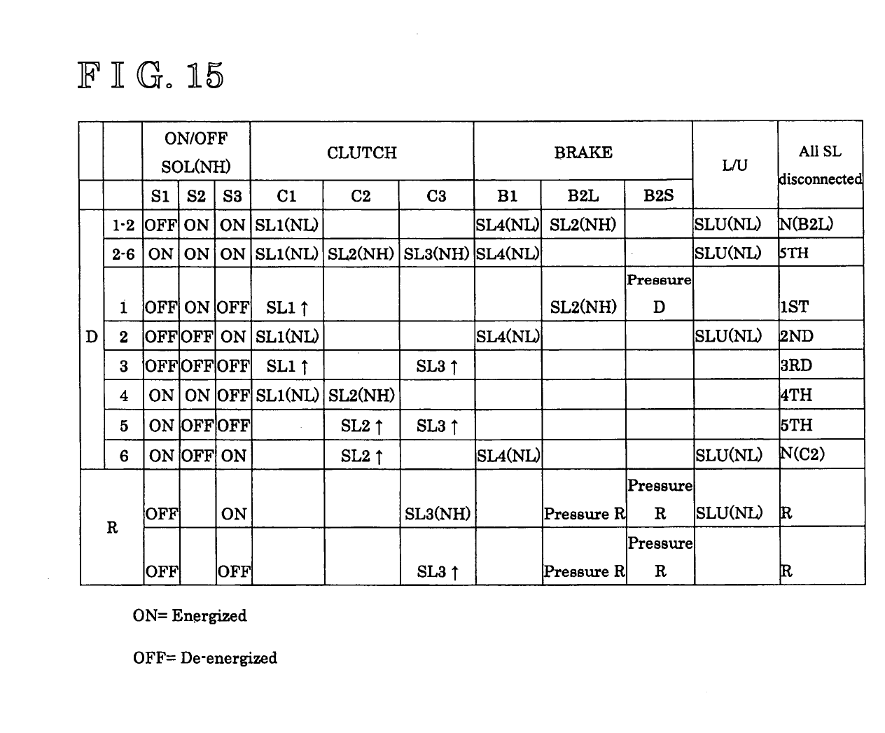

An example 1, which becomes a basis of the hydraulic pressure control apparatus for the automatic transmission related to the first embodiment of the present invention, will be explained in accordance with the attached drawings. FIG. 14 illustrates a schematic partial hydraulic pressure circuit diagram indicating a configuration of the hydraulic pressure control unit of the hydraulic pressure control apparatus for the automatic transmission related to the example 1. FIG. 15 illustrates a table indicating a relation between each driving range and each shifting pattern set according to the controlling state of the hydraulic pressure control unit of the hydraulic pressure control apparatus for the automatic transmission related to the example 1.

In the hydraulic pressure circuit illustrated in FIG. 14, the third control valve unit SL3 for the third friction clutch C3 can be controlled at the neutral range so as to reduce the number of the accumulator comparing to that in the known art. In the example 1, the pressure D is supplied to the drain port Dr of the first control valve unit SL1 (NL) when the first on/off solenoid valve S1 (NH) is energized, and the third on/off solenoid valve S3 (NH) is energized, the pressure D is supplied to the drain port Dr of the third control valve unit SL3 (NH) when the second on/off solenoid valve S2 (NH) is energized and the third on/off solenoid valve S3 (NH) is energized, and the pressure D is supplied to the drain port Dr of the second control valve unit SL2 (NH) when the first on/off solenoid valve S1 (NH) is de-energized, and the second on/off solenoid valve S2 (NH) is energized. However, when the first on/off solenoid valve S1 (NH) is energized, the second on/off solenoid valve S2 (NH) is energized, and the third on/off solenoid valve S3 (NH) is de-energized (second shift stage fixed mode); the first on/off solenoid valve S1 (NH) is de-energized, the second on/off solenoid valve S2 (NH) is de-energized, and the third on/off solenoid valve S3 (NH) is energized (fourth shift stage fixed mode); and the first on/off solenoid valve S1 (NH) is de-energized, the second on/off solenoid valve S2 (NH) is energized, and the third on/off solenoid valve S3 (NH) is de-energized (sixth shift stage fixed mode), a traveling performance may be reduced upon the malfunction of the control valve unit.

### EXAMPLE 2

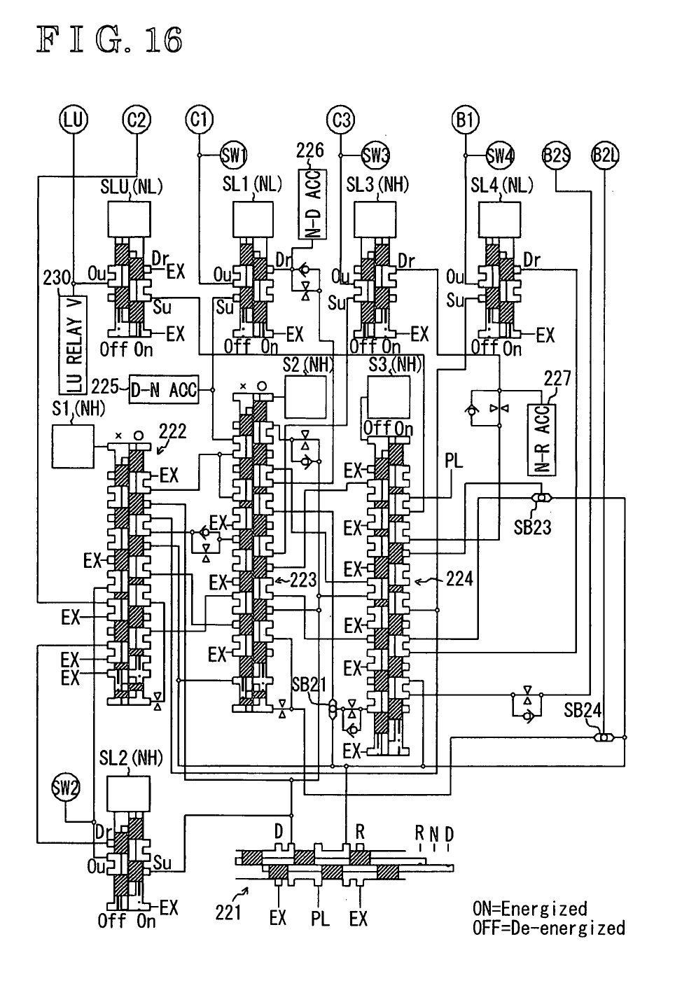

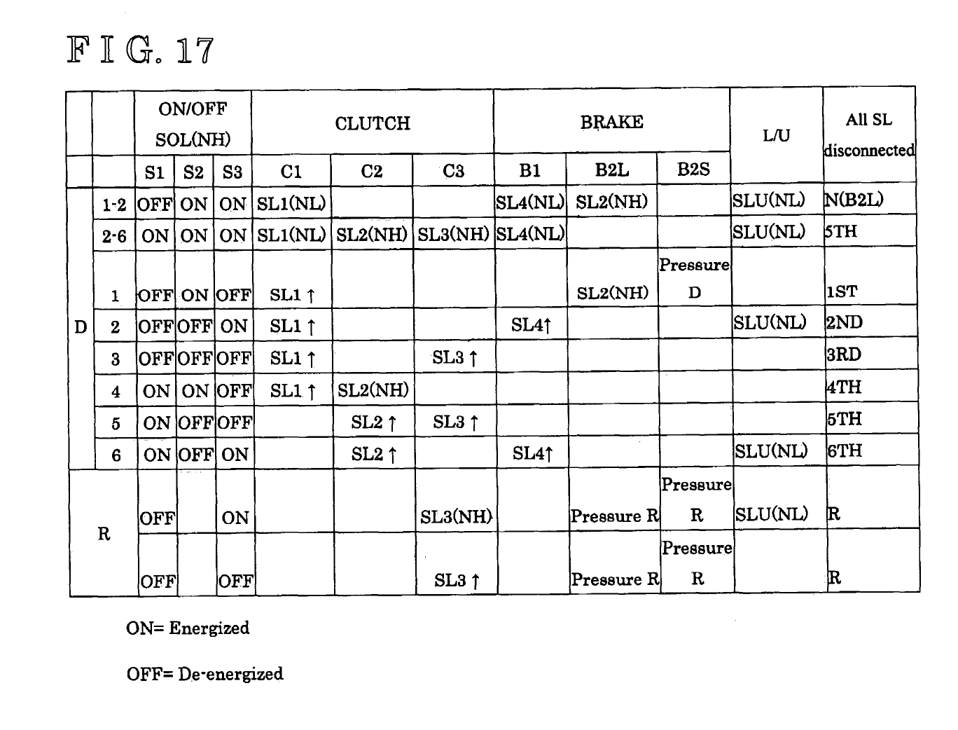

An example 2, which becomes a basis of the hydraulic pressure control apparatus for the automatic transmission related to the first embodiment of the present invention, will be explained in accordance with the attached drawings. FIG. 16 illustrates a schematic partial hydraulic pressure circuit diagram indicating a configuration of the hydraulic pressure control unit of the hydraulic pressure control apparatus for the automatic transmission related to the example 2. FIG. 17 illustrates a table indicating a relation between each driving range and each shifting pattern set according to the controlling state of the hydraulic pressure control unit of the hydraulic pressure control apparatus for the automatic transmission related to the example 2.

In the configuration of the example 2, the traveling performance that can be obtained by the configuration of the example 1 is enhanced. In the example 2, the pressure D is not supplied to the drain port Dr of the first control valve unit SL1 (NL) when the first on/off solenoid valve S1 (NH) is energized, and the third on/off solenoid valve S3 (NH) is energized, and the pressure is supplied to the drain port Dr of the first control valve unit SL1 (NL) when the first on/off solenoid valve S1 (NH) is energized and the second on/off solenoid valve S2 (NH) is energized, and when the second on/off solenoid valve S2 (NH) is de-energized and the third on/off solenoid valve S3 (NH) is energized. Further, the pressure D is supplied to the drain port Dr of the fourth control valve unit SL4 (NL) when the second on/off solenoid valve S2 (NH) is energized, and the third on/off solenoid valve S3 (NH) is de-energized. However, in this configuration of the example 2, an interlock may occur. The first embodiment of the present invention is thus made on the basis of the configuration of the example 2 to which the fail valves (28, 29 in FIG. 4) are added.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. A hydraulic pressure control apparatus for an automatic transmission having plural engaging elements for switching a shift stage by means of a combination of supplying hydraulic pressure to at least one of the plural engaging elements and draining hydraulic pressure from the other of the plural engaging elements, comprising:
plural control valves each having a supply port, a control output port and a drain port for controlling each engaging element to be in an engaged state or in a disengaged state by supplying controlled hydraulic pressure as output pressure, the controlled hydraulic pressure being generated by controlling line pressure supplied to the supply port of the each control valve on the basis an amount of electric power supplied thereto;
the plural engaging elements including a first engaging element and a second engaging element;
the plural control valves including a first control valve and a second control valve, the first control valve corresponding to the first engaging element, and the second control valve corresponding to the second engaging element;
plural shift valves for switching an oil passage for the line pressure supplied from a hydraulic pressure source to the supply port or the drain port of the each control valve;
the second control valve supplying controlled hydraulic pressure to the second engaging element which is interlocking with the first engaging element when each of the first engaging element and the second engaging element is simultaneously in an engaged state;
a fail valve provided at one of: an oil passage provided between the first control valve and the first engaging element, or an oil passage provided between the hydraulic pressure source and the first control valve, having an input port, a fail output port and a release port; and
the fail valve closing the input port and the fail output port thereof while the output pressure is supplied from the second control valve corresponding to the second engaging element; wherein, once the line pressure is supplied to the control valve through the supply port and the drain port thereof, the control valve, whose drain port is connected to the hydraulic pressure source or a exhaust circuit, outputs the line pressure from the control output port as output pressure, and once the line pressure is supplied to the fail valve through the input port and the release port thereof, the fail valve, whose release port is connected to the hydraulic pressure source or the exhaust circuit, outputs the line pressure from the fail output port as output pressure.

2. The hydraulic pressure control apparatus for the automatic transmission according to claim 1, wherein each of the drain port of the first control valve and the release port of the fail valve is connected to the exhaust circuit via one of/all of the plural shift valves, while the line pressure is supplied to the second control valve via the one of/all of the plural shift valves.

3. The hydraulic pressure control apparatus for the automatic transmission according to claim 1, wherein line pressure is supplied to the drain port of the first control valve and the release port of the fail valve via one of/all of the plural shift valves, while the line pressure is not supplied to the second control valve via the one of/all of the plural shift valves, and while the first engaging element is used for establishing a specific shift stage.

4. The hydraulic pressure control apparatus for the automatic transmission according to claim 2, wherein line pressure is supplied to the drain port of the first control valve and the release port of the fail valve via one of/all of the plural shift valves, while the line pressure is not supplied to the second control valve via the one of/all of the plural shift valves, and while the first engaging element is used for establishing a specific shift stage.

5. The hydraulic pressure control apparatus for the automatic transmission according to claim 1, wherein each of the drain port of the first control valve and the release port of the fail valve is connected to the exhaust circuit via one of/all of the plural shift valves, while the line pressure is not supplied to the second control valve via the one of/all of the plural shift valves, and while the first engaging element is not used for establishing a specific shift stage.

6. The hydraulic pressure control apparatus for the automatic transmission according to claim 2, wherein each of the drain port of the first control valve and the release port of the fail valve is connected to the exhaust circuit via one of/all of the plural shift valves, while the line pressure is not supplied to the second control valve via the one of/all of the plural shift valves, and while the first engaging element is not used for establishing a specific shift stage.

7. The hydraulic pressure control apparatus for the automatic transmission according to claim 3, wherein each of the drain port of the first control valve and the release port of the fail valve is connected to the exhaust circuit via one of/all of the plural shift valves, while the line pressure is not supplied to the second control valve via the one of/all of the plural shift valves, and while the first engaging element is not used for establishing a specific shift stage.

8. The hydraulic pressure control apparatus for the automatic transmission according to claim 4, wherein each of the drain port of the first control valve and the release port of the fail valve is connected to the exhaust circuit via one of/all of the plural shift valves, while the line pressure is not supplied to the second control valve via the one of/all of the plural shift valves, and while the first engaging element is not used for establishing a specific shift stage.

9. The hydraulic pressure control apparatus for the automatic transmission according to claim 1, wherein the release port of the fail valve is connected to the drain port of the second control valve by means of an oil passage.

10. The hydraulic pressure control apparatus for the automatic transmission according to claim 2, wherein the release port of the fail valve is connected to the drain port of the second control valve by means of an oil passage.

11. The hydraulic pressure control apparatus for the automatic transmission according to claim 3, wherein the release port of the fail valve is connected to the drain port of the second control valve by means of an oil passage.

12. The hydraulic pressure control apparatus for the automatic transmission according to claim 4, wherein the release port of the fail valve is connected to the drain port of the second control valve by means of an oil passage.

13. The hydraulic pressure control apparatus for the automatic transmission according to claim 5, wherein the release port of the fail valve is connected to the drain port of the second control valve by means of an oil passage.

14. The hydraulic pressure control apparatus for the automatic transmission according to claim 6, wherein the release port of the fail valve is connected to the drain port of the second control valve by means of an oil passage.

15. The hydraulic pressure control apparatus for the automatic transmission according to claim 7, wherein the release port of the fail valve is connected to the drain port of the second control valve by means of an oil passage.

16. The hydraulic pressure control apparatus for the automatic transmission according to claim 8, wherein the release port of the fail valve is connected to the drain port of the second control valve by means of an oil passage.
